(19) United States
(12) Patent Application Publication
(10) Pub. No.: US 2016/0142286 A1
(43) Pub. Date: May 19, 2016

(54) DUAL NODE INTERCONNECTION PROTECTION SWITCHING METHOD AND APPARATUS

(71) Applicant: ELECTRONICS AND TELECOMMUNICATIONS RESEARCH INSTITUTE, Daejeon (KR)

(72) Inventors: Dae Ub KIM, Daejeon (KR); Jeong Dong RYOO, Daejeon (KR); Tae Sik CHEUNG, Daejeon (KR)

(21) Appl. No.: 14/945,945

(22) Filed: Nov. 19, 2015

(30) Foreign Application Priority Data
Nov. 19, 2014 (KR) 10-2014-0161686
Oct. 13, 2015 (KR) 10-2015-0143031

(51) Int. Cl. H04L 12/707

(52) U.S. Cl. CPC H04L 45/22

(57) ABSTRACT

Provided is an operation method of a node, the method including recognizing multiple failures occurring in a protected domain, transmitting a message including failure information, multiple-failure information, and used path information to a second node when the multiple failures are recognized, and performing a protection switching to a used path determined based on a priority for each of the multiple failures.

### CROSS-REFERENCE TO RELATED APPLICATION

This application claims the priority benefit of Korean Patent Application No. 10-2014-0161686 filed on Nov. 19, 2014 and Korean Patent Application No. 10-2015-0143031 filed on Oct. 13, 2015 in the Korean Intellectual Property Office, the disclosures of which are incorporated herein by reference.

### BACKGROUND

1. Field of the Invention

Embodiments relate to a lineal protection switching of a protected domain for protecting a network divided into multiple domains, and more particularly, to a method of connecting two domains protected through a linear protection switching using an interconnection node.

2. Description of the Related Art

In a multiple domain segmented network, a physical connection or a logical connection between a plurality of end nodes 111 and 112 included in a protected domain 110 may be protected through a dual node interconnection protection switching. Referring to FIG. 1, the plurality of end nodes 111 and 112 may be connected to each other through a working path and a protection path. Information used for protection switching may be exchanged between the plurality of end nodes 111 and 112 through the protection path based on a protection switching process performed in each end node. Thus, the end node 111 and the end node 112 may exchange user traffic using the same path. As an example, in a normal state, the plurality of end nodes 111 and 112 may exchange the user traffic through the working path. When the end node 111 detects a failure, for example, a defect from the working path, the plurality of end nodes 111 and 112 may exchange the user traffic using the protection path through information exchange between protection switching processes.

### SUMMARY

According to an aspect, there is provided an operation method of a node, the method including recognizing multiple failures occurring in a protected domain, transmitting a message including failure information, multiple-failure information, and used path information to a second node when the multiple failures are recognized, and performing a protection switching to a used path determined based on a priority for each of the multiple failures.

The recognizing may include recognizing the multiple failures by detecting local failures of differing paths connected to the node, recognizing the multiple failures by verifying multiple-failure information included in a received message, or recognizing the multiple failures by detecting a local failure of a first path connected to the node and verifying information on a remote failure occurring in a path differing from the first path from which the local failure is detected, the information included in a received message.

When the node is a node recognizing a plurality of local failures of differing paths, the transmitting may include transmitting, to the second node, a message including the used path information, the multiple-failure information, and information on a failure corresponding to a relatively high priority among the plurality of local failures.

The performing of the protection switching may include blocking a path connected to a neighboring protected domain of the protected domain, and the second node may unblock a second path connected to the neighboring protected domain.

When the node is a node recognizing a remote failure and a local failure of differing paths, the transmitting may include transmitting a message including the multiple-failure information, the used path information, and information on the local failure to the second node.

When the node is a node recognizing the multiple failures based on multiple-failure information included in a previous received message, the transmitting may include transmitting the message including the failure information, the multiple-failure information, and the used path information to the second node by updating the failure information, the multiple-failure information, and the used path information.

The operation method may further include verifying a solution of the multiple failures in response to a reception of a second message, and performing, when the solution is verified, a revertive switching to a path used before the protection switching is performed.

When the node is an interconnection node recognizing a remote failure and a local failure of differing paths, the operation method may further include transmitting information on a higher priority failure between the local failure and the remote failure to the second node and transmitting information on a subsequent priority failure to the second node in response to a solution of the higher priority failure, and the second node may recognize the solution of the higher priority failure in response to the received information on the subsequent priority failure.

When the node is an interconnection node recognizing a remote failure and a local failure of differing paths, the operation method may further include comparing a priority of the local failure to a priority of a received message and transmitting failure information included in the received message to the second node when the priority of the received message is higher than the priority of the local failure.

When the node is a protected interconnection node that is connected to a protection path and an interconnected path, and not connected to a working path, the transmitting may include transmitting local failure information of the interconnected path to the second node located on one side of the protection path and a third node located on one side of the interconnected path. The transmitting of the local failure information may include transmitting the local failure information to the second node and the third node when the local failure information corresponds to a highest priority failure among the multiple failures, and the operation method may further include transferring, when the local failure information is absent, information on a remote failure included in the multiple failures to an opponent node of a node to which the information on the remote failure is transmitted and transferring, when failure information corresponding to a higher priority than that of the local failure information, the failure information to an opponent node of a node to which the failure information is transmitted.

When a working path failure among the working path failure, an interconnected path failure, and a protection path failure included in the multiple failures is solved, the used path may includes a protection path and an interconnected path in which a failure does not occur.

According to another aspect, there is also provided a node including a processor configured to recognize multiple failures occurring in a protected domain and perform a protection switching to a used path determined based on a priority for each of the multiple failures when the multiple failures are recognized, and a communicator configured to transmit a message including failure information, multiple-failure information, and used path information to a second node.

When the processor recognizes a plurality of local failures of differing paths, the communicator may be configured to transmit a message including the used path information, the multiple-failure information, and information on a failure having a relatively high priority among the plurality of local failures to the second node.

The processor may be configured to block a path connected to a neighboring protected domain of the protected domain, and the second node may unblock a second path connected to the neighboring protection node.

When the node is an interconnection node recognizing a remote failure and a local failure of a differing path, the communicator may be configured to transmit information on a higher priority failure between the local failure and the remote failure to the second node and transmit information on a subsequent priority failure to the second node in response to a solution of the higher priority failure, and the second node may recognize the solution of the higher priority failure in response to the received information on the subsequent priority failure.

When the processor recognizes the multiple failures based on multiple-failure information included in a previous received message, the communicator may be configured to transmit the message including the failure information, the multiple-failure information, and the used path information to the second node by updating the failure information, the multiple-failure information, and the used path information.

The processor may be configured to verify a solution of the multiple failures in response to a reception of a second message and perform a revertive switching to a path used before the protection switching is performed when the solution is verified.

When the node is a first protected interconnection node not having a local failure, and when the second node is a second protected interconnection node having the local failure and connected to the node through a protection path, the communicator may be configured to receive a second message including local interconnected path failure information, the multiple-failure information, and protection path use information from the second node, receive a third message including no request information from a third node in response to a solution of one of the multiple failures recognized based on multiple-failure information included in a previous received message, and transmit the no request information to the second node.

When a working path failure among the working path failure, an interconnected path failure, and a protection path failure included in the multiple failures is solved, the used path may include a protection path and an interconnected path in which a failure does not occur.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of an architecture of a linear protection switching;

FIGS. 2A and 2B illustrate an example of an end node in the architecture of the linear protection switching of FIG. 1;

FIGS. 3A through 3C illustrate an example of an interconnection between protected domains using dual nodes;

FIG. 4 illustrates an example of an interconnection between differing protected domains;

FIGS. 5A through 5D illustrate an example of a failure monitoring method;

FIGS. 6A through 6D illustrate an example of an interconnection between protected domains in a network divided into multiple domains;

FIGS. 7A through 7D illustrate an example of a protection switching;

FIGS. 8A through 8C illustrate another example of a protection switching;

FIG. 9 illustrates still another example of a protection switching;

FIG. 10 is a flowchart illustrating an example of an operation method of a node; and

FIG. 11 is a block diagram illustrating an example of a node.

### DETAILED DESCRIPTION

Hereinafter, example embodiments will be described in detail with reference to the accompanying drawings.

It should be understood, however, that there is no intent to limit this disclosure to the particular example embodiments disclosed. On the contrary, example embodiments are to cover all modifications, equivalents, and alternatives falling within the scope of the example embodiments.

As used herein, the singular forms “a,” “an” and “the” are intended to include the plural forms as well, unless the context clearly indicates otherwise. It will be further understood that the terms “include” and/or “have,” when used in this specification, specify the presence of stated features, integers, steps, operations, elements, components or combinations thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which these example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

A linear protection switching method may include International Telecommunication Union Telecommunication (ITU-T) recommendations G.8031, Ethernet lineal protection switching, G.873.1, Optical transport network (OTN) linear protection switching, and G.8131, Multiprotocol label switching-transport profile (MPLS-TP) linear protection switching, or Internet Engineering Task Force (IETF) request for comments (RFC) 6378 and IETF RFC 7271, MPLS-TP linear protection switching.

Hereinafter, descriptions will be provided as an example of embodiments based on Ethernet communication tutorials. Also, the following example embodiments are provided as a universal lineal protection switching to perform traffic switching, blocking, and unblocking in compliance with various types of packet communication regulations such as OTN, MPLS, and the like.

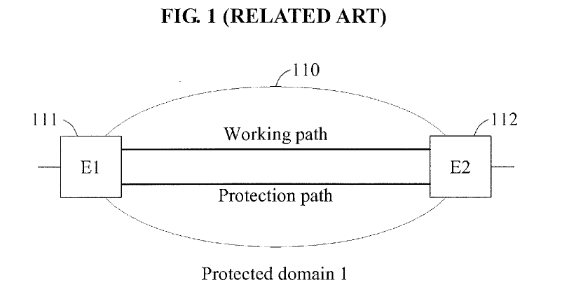

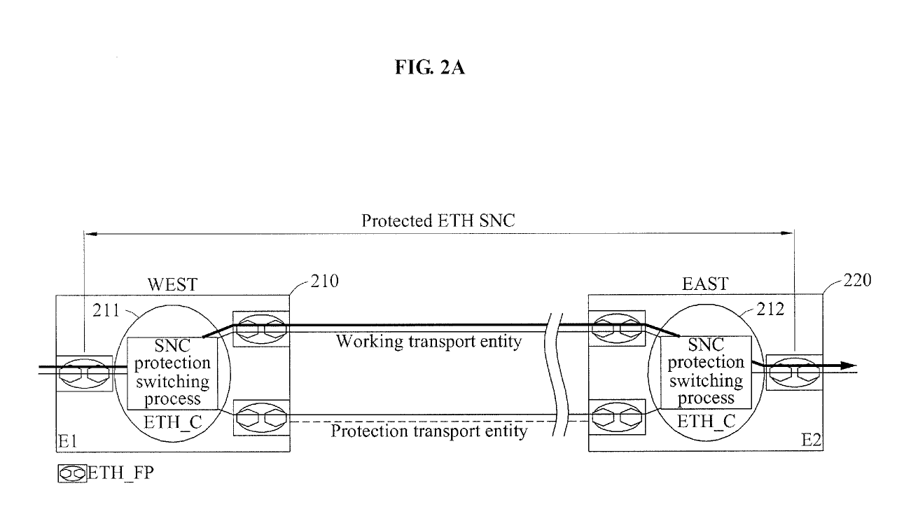

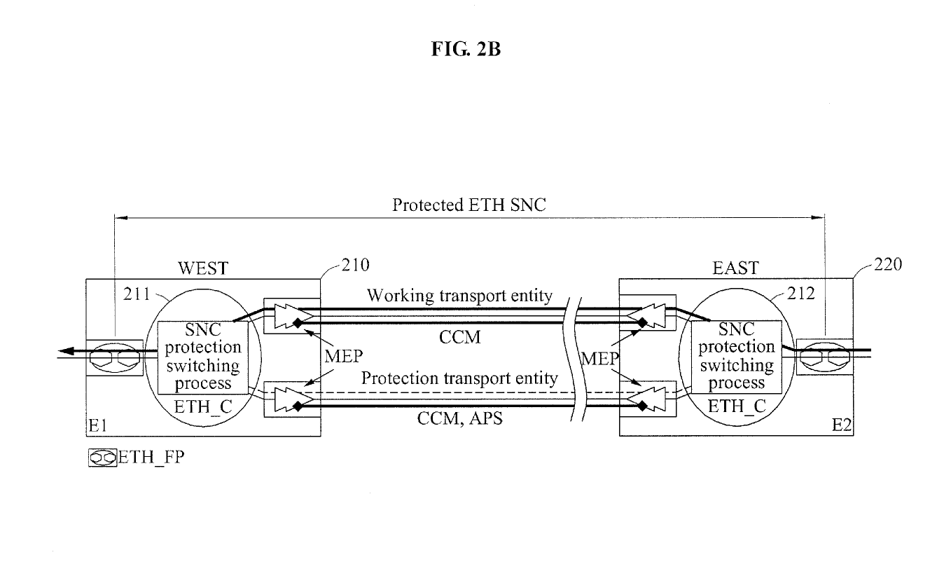

FIGS. 2A and 2B illustrate an example of an end node in an architecture of a linear protection switching of FIG. 1.

A linear protection switching architecture illustrated in FIGS. 2A and 2B may be an Ethernet linear protection switching architecture.

Referring to FIGS. 2A and 2B, a plurality of end nodes 210 and 220 may include an OAM indicating, for example, an element related to operations, administration, and maintenance and configured to detect a failure on a working path, and a maintenance entity group end point (MEP) configured to detect a failure on a protection path and transmit or receive a protection switching message through the protection path based on, for example, a trail monitoring. A state of the working path or the protection path may be monitored based on a method defined on a standard for each network or a predetermined method. By providing failure information of the working path and the protection path, the protection switching may be performed using any monitoring method. For example, the failure information may include a normal state indicated as OK, a signal failure state indicated as Signal Fail, and a signal degradation state indicated as Signal Degrade.

The plurality of end nodes 210 and 220 may also include a bridge. The bridge may selectively transmit user traffic flowing into the protected domain to the working path or the protection path based on a control, for example, path control information of a protection switching process. The plurality of end nodes 210 and 220 may also include a selector.

The selector may select one of the working path or the protection path under the control of the protection switching process, and transfer traffic received through the selected path externally to the protected domain.

The bridge may be a selector bridge configured to select one of the working path or the protection path under the control of the protection switching process and transfer traffic through the selected path. Alternatively, the bridge may be a permanent bridge configured to transfer the same traffic to the working path and the protection path through a replication. Although the bridge is described based on the aforementioned example, a type of the bridge is not limited thereto, and thus various types of bridges are applicable to the present disclosure.

When a predetermined entity controls transmission and reception of traffic based on blocking and unblocking of the traffic, the predetermined entity may be used in substitution for the bridge and the selector.

An Ethernet connection function performer, for example, ETH_C may transmit and receive the traffic through a predetermined path, and execute a function to block and unblock the traffic. For example, Ethernet connection function performers 211 and 212 may control a traffic transference performed between Ethernet flow points (ETH FPs) of Ethernet traffic. Also, the Ethernet connection function performers 211 and 212 may execute a function to switch, block, and/or unblock the traffic as well as perform a traffic switching. Here, the Ethernet connection function performers 211 and 212 may be, for example, the bridge, and the switching may be, for example, a path selection of the bridge and the selector.

The Ethernet connection function performers 211 and 212 may include the protection switching process, and may also transfer information used for the switching and the protection switching process present externally to the Ethernet connection function performers 211 and 212. Also, the Ethernet connection function performers 211 and 212 may apply monitoring information, for example, OAM information, collected at the MEP to control the traffic, and transfer OAM information generated in each of the plurality of end nodes 210 and 220 to another node through the MEP as necessary.

The protection switching process included in each of the plurality of end nodes 210 and 220 may receive the failure information of the working path, the failure information of the protection path, and the protection switching message received from a corresponding end node. Based on the received failure information and the protection switching message, the protection switching process may control the bridge and the selector based on a linear protection switching mechanism. Although not shown in FIG. 2, the protection switching process may control the switching, blocking, and/or unblocking of the traffic based on the linear protection switching mechanism in consideration of a protection switching command input from an operator.

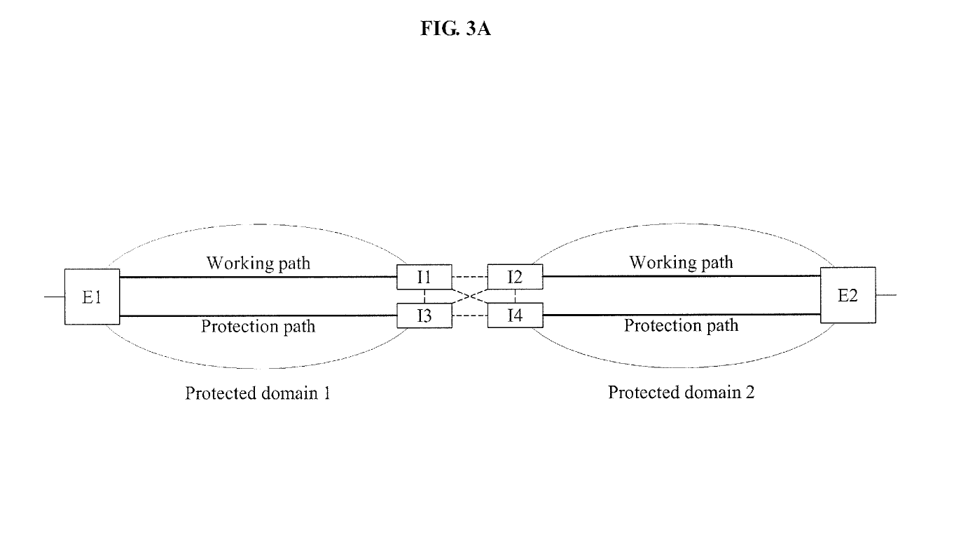

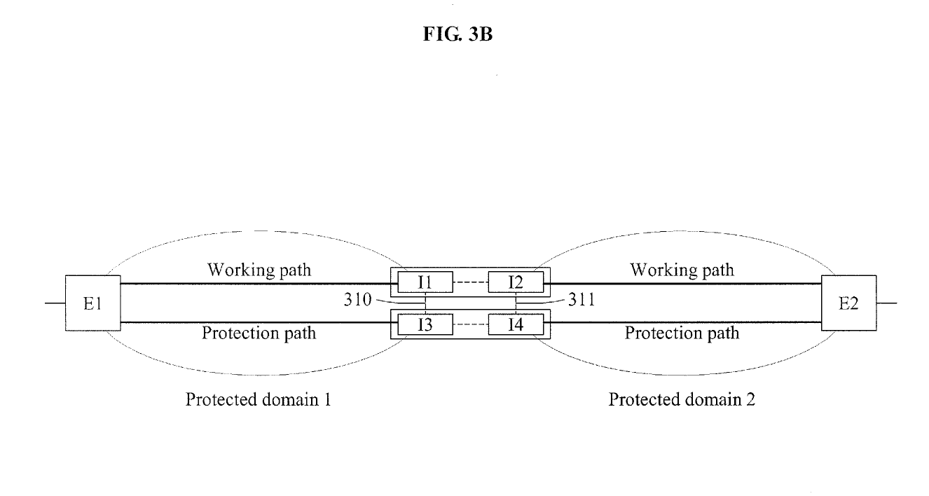

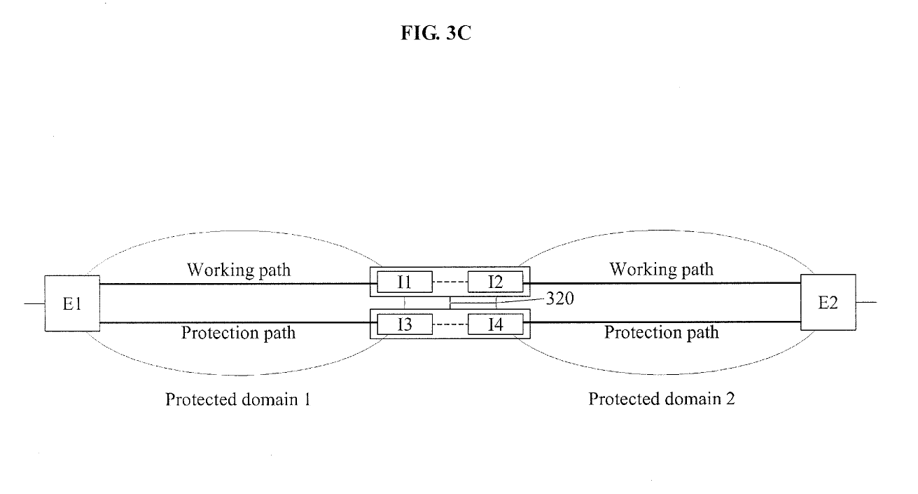

FIGS. 3A through 3C illustrate an example of an interconnection between protected domains using dual nodes.

Referring to FIG. 3A, each of the domains may include two interconnection nodes. A protected domain 1 may include interconnection nodes I1 and I3, and a protected domain 2 may include interconnection nodes I2 and I4. The interconnection nodes may be connected through a logical connection or a physical connection to be in a form of full mesh as illustrated in FIG. 3A.

Referring to FIG. 3B, a plurality of protected domains may physically share two nodes. The protected domains 1 and 2 may share the interconnection nodes I1 and I2, and may also share the interconnection nodes I3 and I4. In contrast to an example of FIG. 3A, a plurality of logical connections among the interconnection nodes may include two physical paths 310 and 311.

Referring to FIG. 3C, a plurality of protected domains may physically share two nodes, and a plurality of logical connections among interconnection nodes may include one physical path 320.

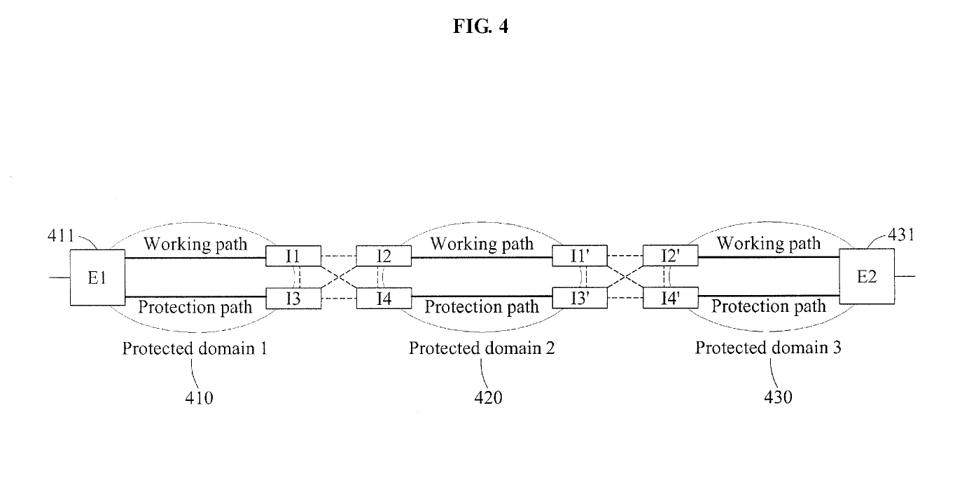

FIG. 4 illustrates an example of an interconnection between differing protected domains.

In FIG. 4, nodes I1 and I3 may be interconnection nodes of a protected domain 410, and nodes I2 and I4 may be interconnection nodes of a protected domain 420. Also, nodes I1′ and I3′ may be interconnection nodes of the protected domain 420, and nodes I2′ and I4′ may be interconnection node of a protected domain 430.

A service between an end node 411 and an end node 431 may be allowed using an interconnection node.

Each of the nodes I1, I2, I3, and I4 may be a physically separate node, and the nodes I1 and I3 or the nodes I2 and I4 may be a virtual function block separated based on a function in one physical node. Thus, a configuration of a node may physically vary as illustrated in FIGS. 3B and 3C. A path described below may be, for example, a physical path and a logical path.

The interconnection nodes I1, I2, I3, and I4 may be connected through an interconnected path, and connected to be in a form of a physical full mesh or a logical full mesh based on a network configuration. Also, the interconnection nodes may be connected in a form of a partial mesh. Since the connection of the interconnection nodes I1, I2, I3, and I4 is based on a virtual path, the interconnection nodes I1, I2, I3, and I4 may be connected in various forms. Although a connection of interconnection nodes is described based on the aforementioned example, the present disclosure is not limited thereto.

An interconnection using dual nodes described with reference to FIGS. 3A through 3C may provide a path through which a connection between two protected domains is maintained despite a failure occurring in one of the dual nodes while a general lineal protection method is inapplicable to each of the protected domains. As an example, in the lineal protection switching, when the working path and the protection path end in the same node, the protection switching process may be performed between two end nodes to select the working path or the protection path. Thus, the general lineal protection switching method may be applied when an end node of the working path is the same as an end node of the protection path. In FIGS. 3A through 3C, since an end point of the working path is different from an end point of the protection path, the general linear protection switching method may not be applied in direct.

Also, when a failure occurs in the interconnection node or at least two paths connected to the interconnection node, the general linear protection switching method may not be applied in direct.

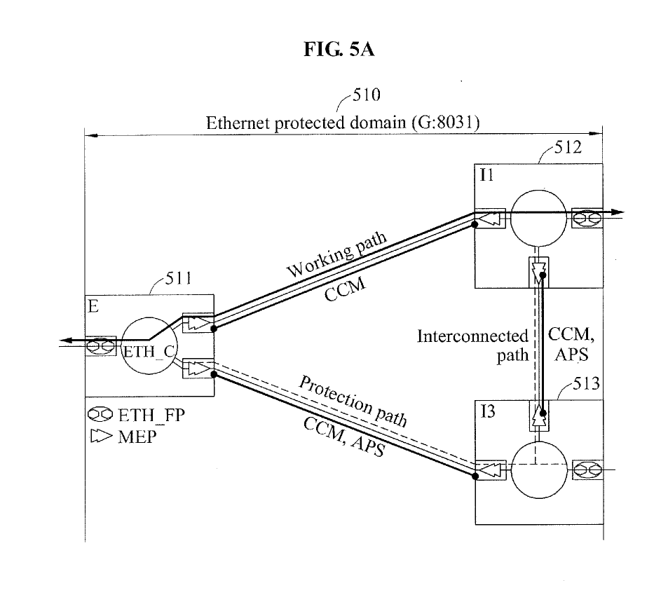

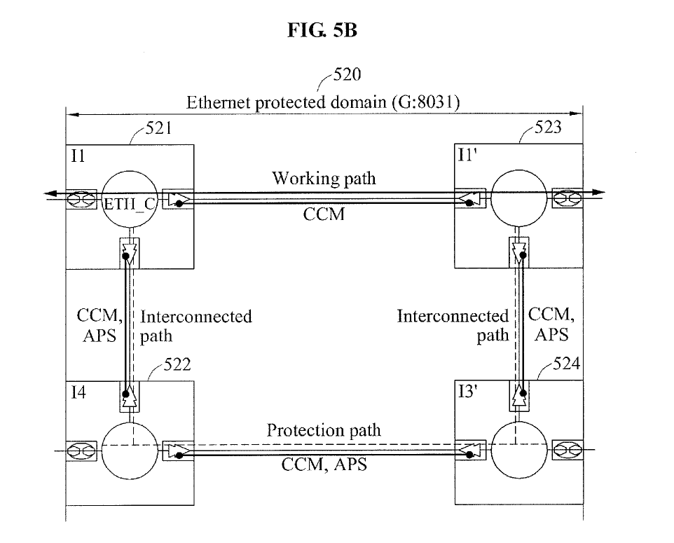

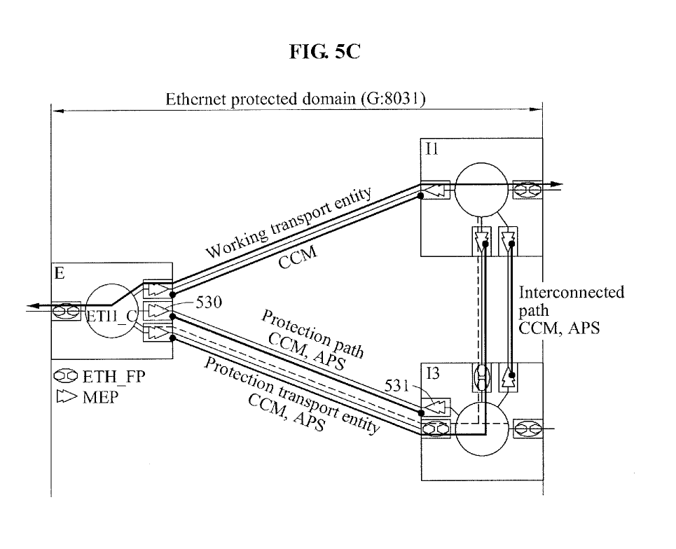

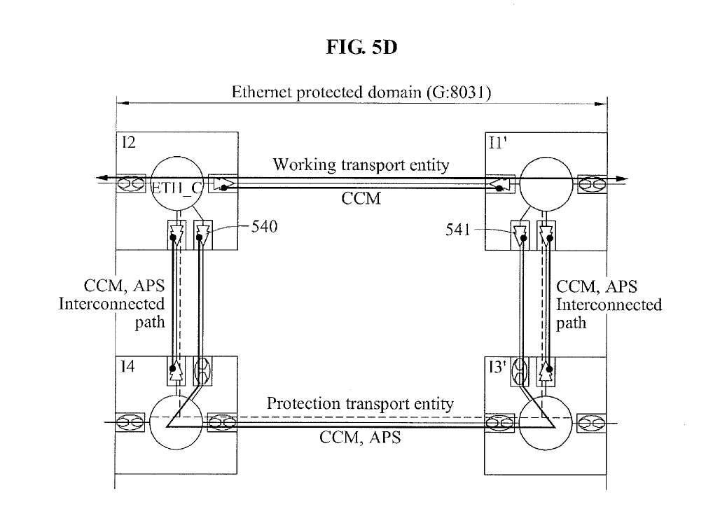

FIGS. 5A through 5D illustrate an example of a failure monitoring method.

Referring to FIG. 5A, a protected domain 510 may include an end node 511 and a plurality of interconnection nodes 512 and 513. A failure of the protected domain 510 may be monitored based on a pair of MEPs for each path of nodes, for example, a pair of MEPs on a working path, a pair of MEPs on a protection path, and a pair of MEPs on an interconnected path.

Referring to FIG. 5B, a protected domain 520 may include a plurality of interconnection nodes 521 through 524. A failure of the protected domain 520 may be monitored based on a pair of MEPs for each path, for example, a pair of MEPs on a working path, a pair of MEPs on a protection path, and a pair of MEPs on an interconnected path.

Referring to FIG. 5C, a protected domain may include an end node and a plurality of interconnection nodes. In comparison to an example of FIG. 5A, a pair of MEPs 530 and 531 for monitoring a protection path may be used in addition.

Referring to FIG. 5D, a protected domain may include a plurality of interconnection nodes. In comparison to an example of FIG. 5B, a pair of MEPs 540 and 541 for monitoring a working path and a protection path may be used in addition.

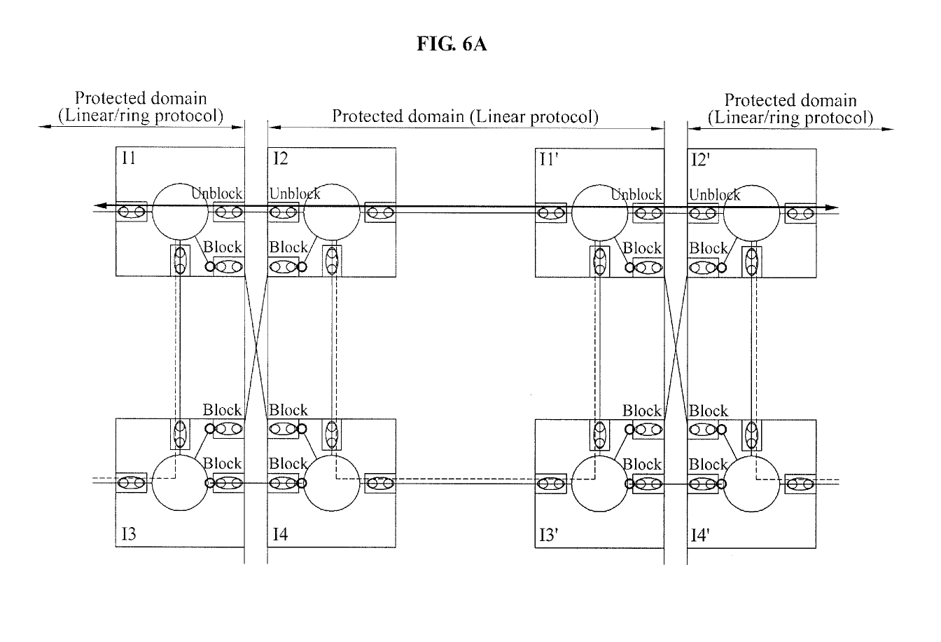

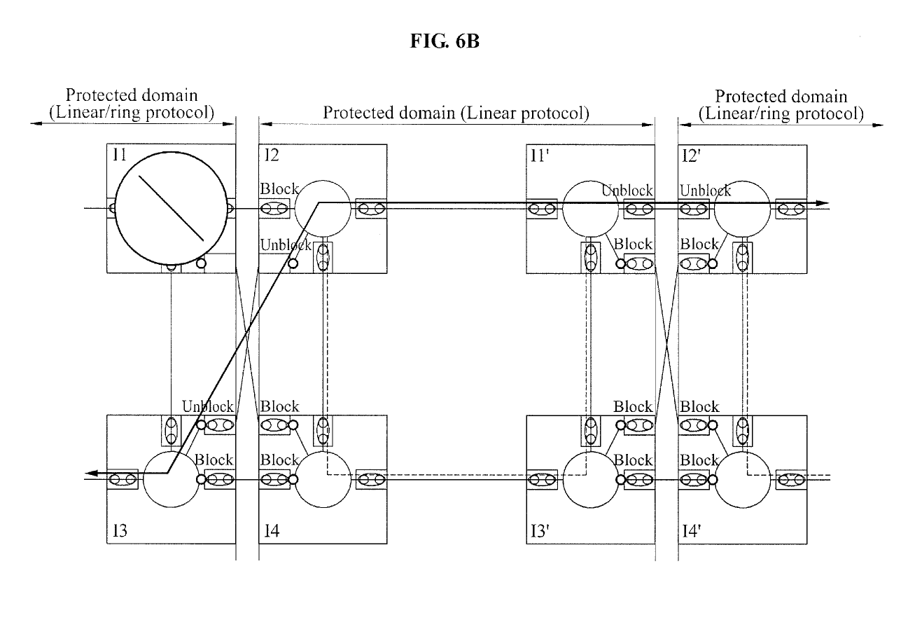

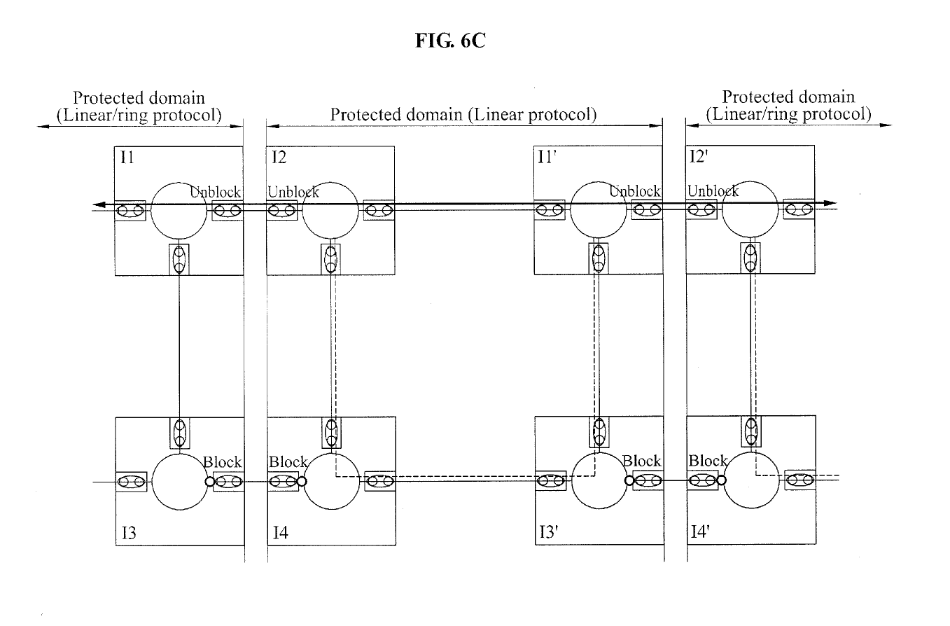

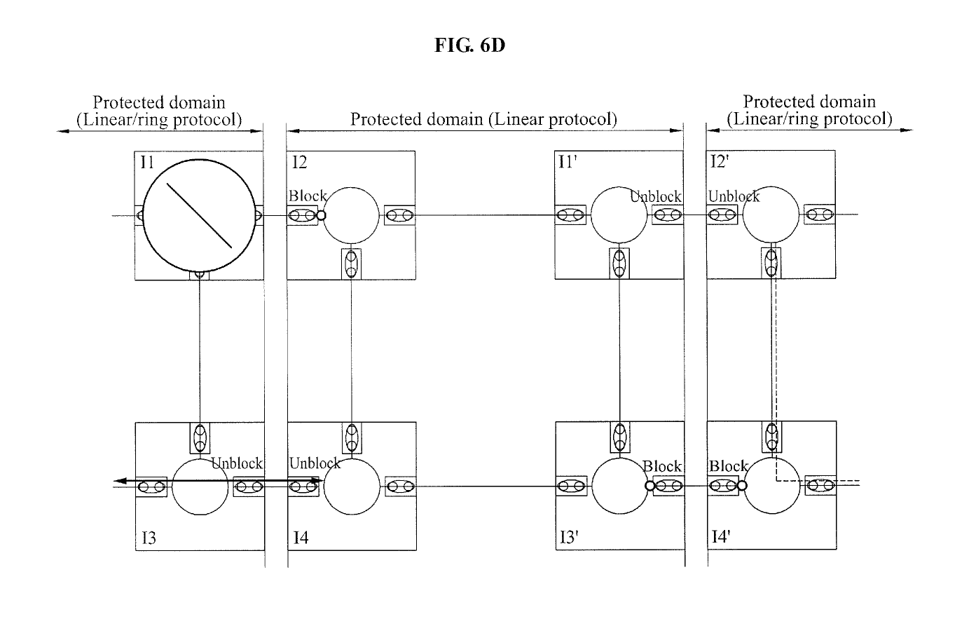

FIGS. 6A through 6D illustrate an example of an interconnection between protected domains in a network divided into multiple domains.

A node located in one side of a working path may also be referred to as, for example, a working interconnection node, and a node located in one side of a protection path may also be referred to as, for example, a protected interconnection node.

Referring to FIGS. 6A through 6C, in a normal state not having a failure, a working interconnection node I1 and a protected interconnection node I3 may transmit and receive path control information to perform a traffic exchange through a working path. A working interconnection node I1′ and a protected interconnection node I3′ may transmit and receive path control information to perform a traffic exchange through a working path.

The working interconnection node I1 may unblock a path connected to a working interconnection node I2 in another protected domain to transfer traffic through a working path of the other protected domain, and block at least one interconnected path to avoid a loop of interconnected paths in a corresponding protected domain. For example, the working interconnection node I1 may control a connection of the interconnected path based on the path control information.

The working interconnection node I1′ may unblock a path connected to a working interconnection node I2′ in another protected domain to transfer traffic through a working path of the other protected domain, and block at least one interconnected path to avoid a loop of interconnected paths in a corresponding protected domain.

Referring to FIG. 6A, a connection of a plurality of interconnection nodes I1, I2, I3, and I4 and a connection of a plurality of interconnection nodes I1′, I2′, I3′, and I4′ may be a mesh connection. Referring to FIG. 6C, interconnection nodes I1 and I2 may be connected to each other, and interconnection nodes I3 and I4 may be connected to each other.

FIG. 6B illustrates an example of unblocking and/or blocking an interconnected path for loop prevention when a failure occurs in a working interconnection node, for example, the interconnection node I1 of FIG. 6A, or failures occur in two paths connected to the working interconnection node. FIG. 6D illustrates an example of unblocking and/or blocking an interconnected path for loop prevention when a failure occurs in a working interconnection node, for example, the interconnection node I1 of FIG. 6C.

When the working interconnection node or paths connected to the working interconnection node is recovered, and when a protected interconnection node transfers traffic as illustrated in FIG. 6B or 6D, a failure may occur in the protected interconnection node or at least one path connected to the protected interconnection node. In this example, the protected interconnection node may block a path in which the failure occurs, and unblock and/or block a remaining path as illustrated in FIG. 6A or 6C. Through this, the working interconnection node may transmit and receive the traffic.

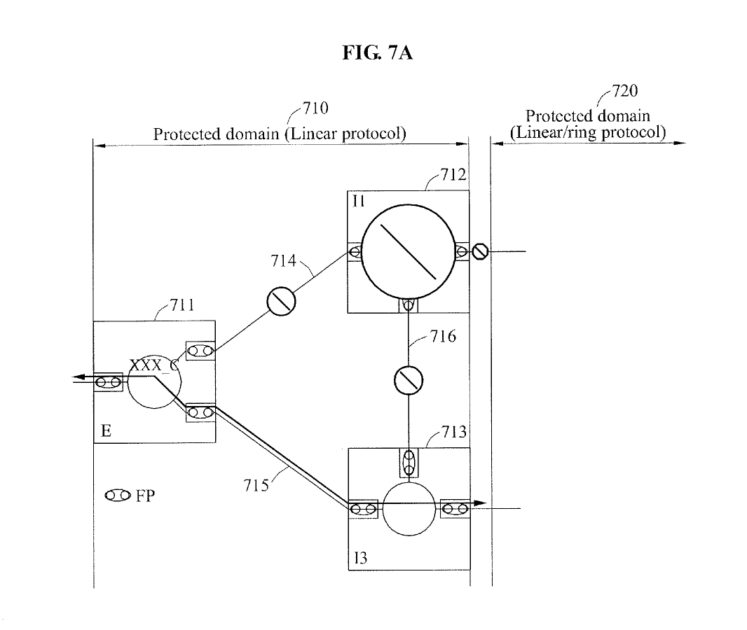

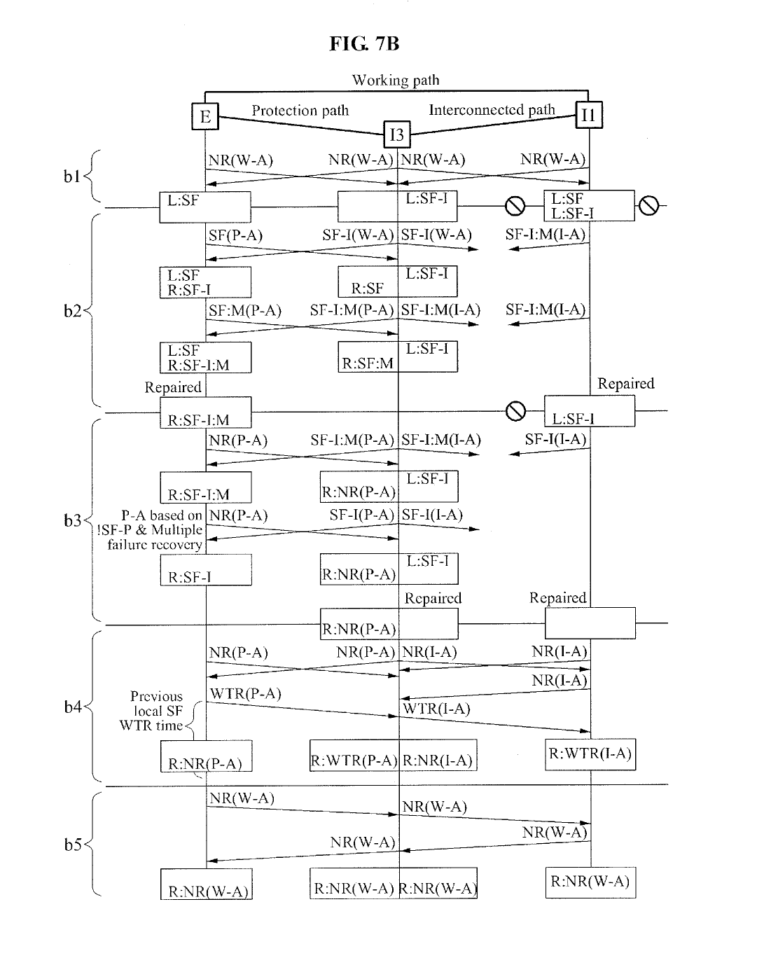

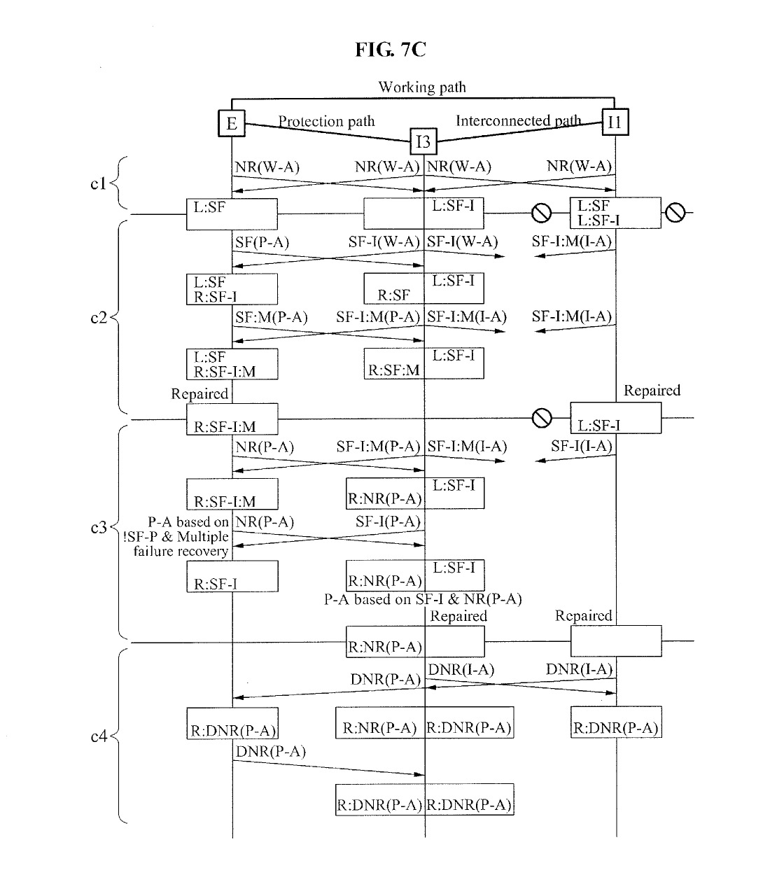

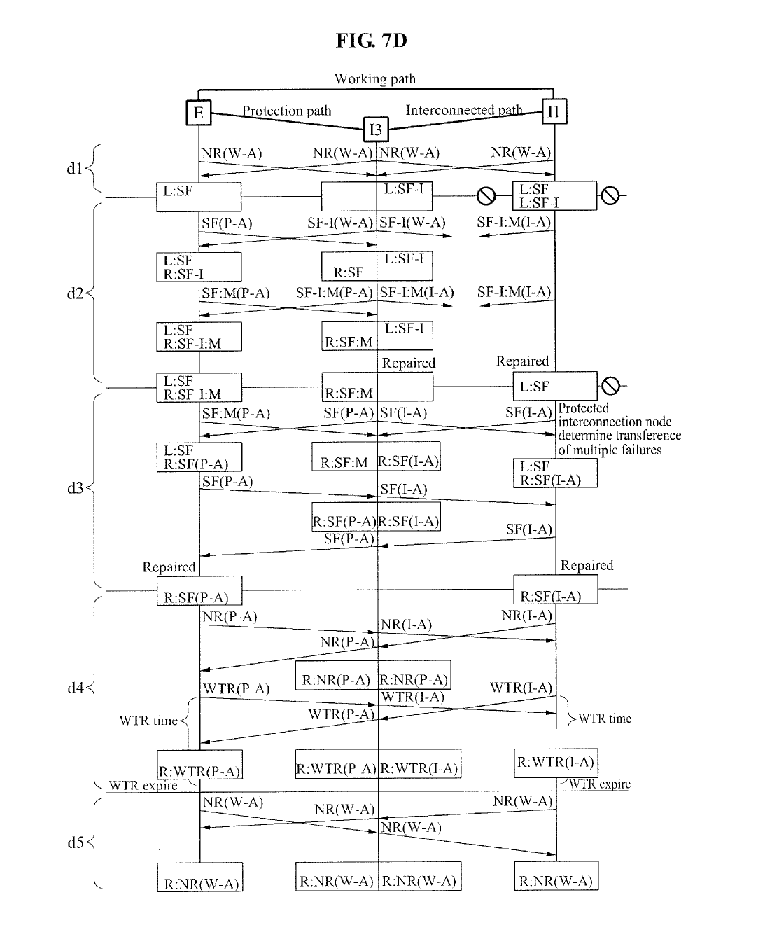

FIGS. 7A through 7D illustrate an example of a protection switching.

Referring to FIG. 7A, a protected domain 710 may include an end node 711, a working interconnection node 712, and a protected interconnection node 713. As described above, an interconnection node located in one side of a working path 714 may be the working interconnection node 712, and an interconnection node located in one side of the protection path 715 may be the protected interconnection node 713. In this example, when a failure occurs in the working interconnection node 712 of the protected domain 710, or when a failure occurs in a path connected to the working interconnection node 712, the protection switching may be initiated. FIG. 7A illustrates an example of the protection switching.

Similarly to an example of FIG. 5A, an MEP, for example, for trail monitoring, may be configured to monitor a path state for each path, and failure information may be transferred through paths to be used as a protection path. In terms of the Ethernet, the monitoring may be performed on, for example, a state of transmitting and receiving a continuity check message (CCM). For example, failure and request information transference message may be transmitted and received through a path between nodes E and I3 and a path between nodes I1 and I3. In terms of the Ethernet, the transmitting and receiving may be performed on an Automatic Protection Switching (APS) message. In this example, the failure and request information transference message and the APS message may be, for example, a message, a failure message, and an information transference message. Failure information obtained through monitoring and transferred failure information may be processed as follows.

In an normal state in which a failure does not occur, the protection switching may be initiated when failures occur in a first path, for example, the working path 714 and the a third path 716 or a failure occurs in the working interconnection node 712. Hereinafter, descriptions related to the protection switching will be provided with reference to FIGS. 7B through 7D.

FIG. 7B illustrates an example, of the protection switching performed in a revertive mode.

(b 1)—Normal State

In a normal state, nodes E, I3, and I1 may transmit and receive a message including W-A information and no request information. Hereinafter, NR may indicate, for example, no request.

(b 2)—Occurrence of Multiple Failures

Failures, for example, multiple failures, may occur in a working path and an interconnected path in a protected domain.

A predetermined node may recognize the multiple failures. As an example, the predetermined node may recognize the multiple failures by detecting local failures of at least two differing paths. Thus, the predetermined node may recognize the multiple failures by detecting local failures of differing paths connected to the predetermined node. Also, the predetermined node may recognize the multiple failures by detecting a local failure and verifying remote failures of differing paths based on a received message. Thus, the predetermined node may recognize the local failure and the remote failure of the differing paths. For example, the predetermined node may detect a local failure of a first path connected to the predetermined node and verify remote failure information included in the received message, thereby recognizing the multiple failures. Here, the remote failure information may indicate failure information on a path differing from the first path in which the local failure is detected. Also, the predetermined node may recognize the multiple failures by verifying the multiple-failure information included in the received message.

When the predetermined node recognizes local failures of at least two differing paths, a message information on a local failure corresponding to a highest priority between the at least two local failures may be transmitted to a neighboring node. In this example, a message including multiple-failure information, for example, M information, and used path information may be transmitted to the neighboring node.

When the predetermined node recognized a local failure and a remote failure of differing paths, a message including local failure information, multiple-failure information, and used path information may be transmitted to the neighboring node.

When the predetermined node recognized the multiple failures based on the received message, a message including local failure information, multiple-failure information, and used path information may be transmitted to the neighboring node. Here, each of the local failure information, the multiple-failure information, and the used path information may be obtained through an update.

When the predetermined node recognized the multiple failures, the protection switching may be performed through a use path determined based on a failure corresponding to a higher priority between the local failure and the remote failure. Information on the determined use path may be transmitted to the neighboring node. Basically, the determined use path may be a path in which the failure corresponding to the highest priority does not occur. When the multiple-failure information is included in the message received by the predetermined node, the predetermined node may match the received used path information and the use path of the predetermined node, and perform the protection switching as necessary.

(b 2-1)

The node E may recognize a local working path failure, for example, a signal fail (SF), performs the protection switching, and transmit a message SF(P-A) including protection path use information and local working path information to the node I3. Hereinafter, SF may indicate, for example, the local working path failure, and P-A may indicate, for example, the protection path use.

In response to an occurrence of a failure other than a node failure, the node I1 may verify that the multiple failures occur in the protected domain based on the local working path failure and a local interconnected path failure. The node I1 may transmit a message SF-I:M(I-A) including interconnected path use information and interconnected path failure information and indicating multiple failures, to the node I3. Hereinafter, I-A may indicate, for example, the interconnected path use, SF-I may indicate, for example, the interconnected path failure, and M may indicate, for example, the multiple failures. The message SF-I:M(I-A) may include used path information of the node I1, an identifier indicating an occurrence of the multiple failures, and failure occurrence information, for example, identification information of a path in which a failure occurs. A failure information transference message, the message SF-I:M(I-A), generated in response to the interconnected path failure may not be transferred to the node I3.

The node I3 may recognize the local interconnected path failure, and a message SF-I(W-A) including working path use information and SF-I information by priority, to the node E and the node I1. Hereinafter, W-A may indicate, for example, the working path use.

(b 2-2)

When the node E received the message SF-I(W-A) from the node I3, the node E may verify that multiple failures occur in the protected domain based on a local working path failure, for example, SF, and a remote interconnected path failure, for example, remote SF-I. The node E may transmit a message SF:M(P-A) including P-A information and SF information and indicating multiple failures to the node I3.

The node I1 may not receive a failure information transference message due to an interconnected path failure. Also, a state of the node I1 may not be changed to, for example, a state in which the local working path failure is solved. The node I1 may periodically transmit a message transmitted in advance, for example, the message SF-I:M(I-A) to the node I3.

The node I3 may not receive the message SF-I:M(I-A) from the node I1 due to the interconnected path failure. When the message SF(P-A) is received from the node E, the node I3 may verify that the multiple failures occur in the protected domain based on the local interconnected path failure and the remote working path failure. Through this, the node I3 may perform the protection switching, and transmit the message SF-I:M(P-A) including the P-A information and the SF-I information and indicating the multiple failures M to the node E and the node I1.

In this instance, the protection switching in which the traffic is transmitted and received through the interconnected path or the protection path may be terminated.

(b 2-3)

When the node E receives the message SF-I:M(P-A) from the node I3, the node E may verify that the multiple failures occur and the protection switching is performed. The node E may transmit the message SF:M(P-A) including the P-A information and the SF information and indicating the multiple failures M, to the node I3.

When the node I3 received the message SF:M(P-A) from the node E, the node I3 may recognize the occurrence of the multiple failures and transmit the message SF-I:M(P-A) including the P-A information and the SF-I information and indicating the multiple failures M, to the node E and the node I1. In this example, the message SF-I:M(P-A) may include the identifier indicating the occurrence of the multiple failures, the used path information of the node I3, and path occurrence information, for example, including identification information of an interconnected path in which a failure occurs.

An interconnection node, for example, a working interconnection node I1 recognizing multiple local failures may block a path connected to another protected domain. Another interconnection node, for example, a protected interconnection node I3 recognizing multiple failures occurring paths of the protected domain other than local paths of the protected interconnection node I3 may unblock a path connected to the other protected domain such that traffic is normally transmitted from the protected domain and the other protected domain.

(b 3)—Working Path Failure a Solution

A case in which a working path failure is solved

(b 3-1)

When the local working path failure is solved, the node E may transmit a message NR(P-A) including the P-A information and the NR information, to the node I3. The message NR(P-A) may include the used path information of the node E and failure occurrence information, for example, including information on a solution of the working path failure.

Although the local working path failure is solved, the local interconnected path failure may remain and thus, the node I1 may not receive the failure information transference message from the node I3. When the local working path failure is solved, a multiple failure occurring state may end. Thus, although the node I1 transmits the message including the I-A information and the SF-I information to the node I3, the failure information transference message may not be transferred to the I3 node.

The node I3 may maintain a previous state, for example, the multiple failures occurring state until the failure information transference message is received from another node, for example, the node E despite a recovery of the working path, and continuously transmit a state message transmitted in advance, the message SF-I:M(P-A), to the node E and the node I1.

(b 3-2)

When the message NR(P-A) is received from the node E, the node I3 may transmit a message including the P-A information and the SF-I information, for example, the message SF-I(P-A) to the node E. Thus, although the multiple failure occurring state ends in response to the solution of the working path failure, the local interconnected path failure may remain and thus, the node I3 may transmit the message SF-I(P-A). Although the node I3 transmits a message including the interconnected path use information I-A and the SF-I information to the node I1, the message SF-I(I-A) may not transferred to the node I1 due to an unsolved interconnected path failure.

When the node E receiving the message SF-I:M(P-A) receives the message SF-I(P-A), the node E may recognized that the multiple failures are absent in the protected domain.

(b 4)—all Failures are Solved in Response to a Solution of an Interconnected Path Failure in a Revertive Mode.

When all of the multiple failures of the protected domain are solved, nodes may maintain used paths. For example, the nodes E, I1, and I3 may verify that all of the multiple failures of the protected domain are solved in response to a message. In this example, the nodes E, I1, and I3 may maintain currently used paths until the nodes E, I1, and I3 verify that all of the multiple failures are solved. When the nodes E, I1, and I3 verify that all of the multiple failures are solved, the nodes E, I1, and I3 may perform the revertive switching in the revertive mode.

(b 4-1)

To provide notification indicating that the local interconnected path failure is solved, the node I1 may transmit the message NR(I-A) including the I-A information and the NR information to the node I3.

To provide notification indicating that the local interconnected path failure is solved, the node I3 may transmit the message NR(I-A) including the I-A information and the NR information to the node I1. Also, the node I3 may transmit the message NR(P-A) including the P-A information and the NR information to the node E. The node I3 may be in a state in which the node I3 is using the protection path and the interconnected path and transmitting no request, and may maintain a current state until a new message is received. For example, the node I3 may use the protection path and the interconnected path and maintain a no request transmitting state until the new message is received.

When the node E receiving a message remote SF-I(P-A) receives the message NR(P-A) including the P-A information and the NR information from the node I3, the node E may verify that all failures of the protected domain are solved. Since the preceding local failure is the working path failure, the node E may operate a wait to restore (WTR) timer in the revertive mode and transmit the message WTR(P-A) including the P-A information and the WTR operating information to the node I3.

When the node I3 receives the WTR message including the P-A information from the node E, the node I3 may transmit the message WTR(I-A) including the I-A information and the WTR operating information to the node I1 such that the node I1 is informed that the WTR timer is operated in the protected domain.

When the node I3 recognizes that all of the failures are solved, the WTR timer may not also be operated by the node I3. The WTR timer may be operated by the node E and the node I1, each connected to the working path and recognizing the local failure.

(b 5)—WTR Timer Expiration

A case in which the WTR timer is expired

(b 5-1)

When the WTR timer is expired, the node E may perform the revertive switching, and transmit the message NR(W-A) including the W-A information and the NR information to the node I3.

The node I3 may receive the message including the W-A information and the NR information from the node E. Also, when the used path information the same as the used path information of the node E is received from the node I1, the node I3 may perform the retuning switching. When the node I3 received the message NR(W-A) from the node E, the node I3 may defer the revertive switching and transmit the message including the W-A information and the NR information to the node I1. When the message including the W-A information and the NR information is received from the node I3, the node I1 may perform the revertive switching and transmit the message including the W-A information and the NR information.

When the message including the W-A information and the NR information is received from the node I1, the node I3 may perform the revertive switching.

When the multiple failures, for example, the working path failure, occur in the protected domain in the revertive mode, the used path may be switched to the protection path. When the multiple failures are solved, the used path may be reverted to be the working path. The protection switching process performed in the revertive mode is described with reference to the foregoing examples. Hereinafter, a protection switching process performed in a non-revertive mode will be described with reference to FIG. 7C.

FIG. 7C illustrates an example of a protection switching process performed in a non-revertive mode when multiple failures occur in a protected domain.

(c 1) through (c 3) of the protection switching process in the non-revertive mode may be the same as (b-1) through (b 3) of the protection switching process in the revertive mode.

(c 4)—Interconnected Path Failure Solution

When the multiple failures are solved, the node I1 may transmit a message DNR(I-A) to the node I1 to provide notification indicating that the local interconnected path failure is solved. Here, DNR indicates Do-not-Revert. In contrast to FIG. 7C, since the node I1 is in the non-revertive mode, the node I1 may transmit the message DNR(I-A) to the node I1.

To provide notification indicating that the local interconnected path failure is solved, the node I3 may transmit a message including the I-A information and DNR state information to the node I1, and transmit a message including the P-A information and the DNR state information to the node E. In contrast to FIG. 7B, since the node I3 is in the non-revertive mode, the node I3 may transmit the message DNR(P-A) to the node I1 and the node E.

When the node E receiving the message remote SF-I(P-A) receives the message including the P-A information and the DNR state information, the node E may verify that all of the failures in the protected domain are solved. Since the node E is in the non-revertive mode, the node E may transmit the DNR message including the P-A information to the node I3.

Although the multiple failures occurring in the protected domain are solved, the used path may not be reverted to be the working path, and the protection path and the interconnected path may be used as the used path or a non-revertive process may be performed.

FIG. 7D illustrates another example of a protection switching process performed in a revertive mode when multiple failures occur in a protected domain.

In contrast to FIG. 7B, an interconnected path failure may be solved, and then a working path failure may be solved in an example of FIG. 7D.

(d 1) and (d 2) of the protection switching process in an example of FIG. 7D may be the same as (b 1) and (b 2) of the protection switching process in an example of FIG. 7B. Hereinafter, (d 3) will be described as follows.

(d 3)—Interconnected Path Failure Solution

A case in which the interconnected path failure is solved

(d 3-1)

Since the local interconnected path failure is solved and the local working path failure remains, the node I1 may transmit the message SF(I-A) including the I-A information and the SF information to the node I3 to provide notification indicating that the multiple failures are solved.

Since only the local working path failure is effective among failure information collected by the node I3, the node I3 may transmit the message SF(I-A) including the I-A information and the SF information to the node I1, and transmit the message SF(P-A) including the P-A information and the SF information to the node E.

When the node E receiving the message remote SF-I(P-A) receives the message SF(P-A) including the P-A information and the SF information from the node I3, the node E may verify that the interconnected path failure is solved. For example, when the node E receiving the message SF-I(P-A) receives the message SF(P-A), the node E may verify that a single failure remains in the protected domain. The node E may transmit a working path failure message SF(P-A) including the P-A information to the node I3.

The node I3 may transfer information on a failure corresponding to a higher priority between a local failure of the node I3, for example, the interconnected path failure and a remote failure, for example, the working path failure. In d2 of FIG. 7D, the node I3 may transmit the SF-I information corresponding to the higher priority to an opponent node, for example, the node E of the node to which the SF information is transmitted. The interconnected path failure may be solved in d3. In d3, the node E may receive information on a failure corresponding to a lower priority while receiving information on a failure corresponding to the highest priority. In this example, the node E may recognize that the failure corresponding to the highest priority is solved. For example, the node E may recognize that the interconnected path failure which is the remote failure of the node E is solved. The foregoing example may be based on a case in which the node I3 transmitting the information on the failure corresponding to the highest priority to the node E transmits information on a failure corresponding to a subsequent priority when the failure corresponding to the highest priority is solved.

(d 4)—Working Path Failure Solution

A case in which the working path failure is solved

(d 4-1)

The node E may transmit the message NR(P-A) indicating that the local working path failure is solved to the node I3. The message NR(P-A) may include the P-A information and the NR information.

The node I1 may transmit the message NR(I-A) indicating that the local working path failure is solved to the node I3. The message NR(I-A) may include the I-A information and the NR information.

When the message NR(P-A) is received from the node E, the node I3 may transfer the message NR(P-A) to the node I1. Also, when the message NR(I-A) is received from the node I1, the node I3 may transfer the message NR(I-A) to the node E.

(d 4-2)

When the node E receiving the message remote SF(P-A) receives the message NR(P-A) including the P-A information and the NR information from the node I3, the node E may verify that all failures occurring in the protected domain are solved. Since the local failure is the working path failure, the node E may operate the WTR timer in the revertive mode and transmit the message WTR(P-A) including the P-A information and the WTR operating information to the node I3.

When the node I1 receiving the message remote SF(I-A) receives the message NR(P-A) including the I-A information P-A and the NR information, the node I1 may verify that all of the failures occurring in the protected domain are solved. Since the local failure is the working path failure, the node I1 may operate the WTR timer in the revertive mode and transmit the message WTR(I-A) including the I-A information and the WTR operating information to the node I3.

The node I3 may transfer the received message to the opponent node. For example, the node I3 may transfer the message WTR(P-A) to the node I1, and transfer the message WTR(I-A) to the node E.

(d 5)—WTR Timer Expiration

A case in which the WTR timer is expired

(d 5-1)

When the WTR timer is expired, the node E and/or the node I1 may perform the revertive switching and transmit the message NR(W-A) including the W-A information and the NR information to the node I3.

When the node I3 receives the message NR(W-A) from the node E or the node I1, the node I3 may perform the revertive switching and transmit the message NR(W-A) including the W-A information and the NR information to the node E and the node I1.

When the multiple failures such as the working path failure occur, the used path may be switched from the working path to the protection path. When the multiple failures are solved, the used path may be switched from the protection path to the working path. Thus, the used path may be reverted to be the working path.

In an example, an end node and a working interconnection node may monitor a state of the working path. The end node and the working interconnection node may transfer local failure information of the working path and local failure information of the interconnected path to a protected interconnection node. The protected interconnection node may be a node not connected to the working path and may transfer local failure information of a path connected to the protected interconnection node to the nodes located on both side of the protected interconnection node, the end node and the working interconnection node. As an example, when a local failure occurs in the path connected to the protected interconnection node, the protected interconnection node may transfer local failure information to counterpart nodes located on one side of the path in which the local failure occurs.

When a priority of a new received message is higher than that of the local failure or a local request, for example, a request such as WTR and DNR, Lockout, and a manual switch, an interconnection node such as the protected interconnection node may transmit a failure or request included in the received message to a remote node located in an opposite side of a path through which the received message is transferred. In an example of FIG. 7B, when a priority of a new received message is higher than that of the local failure or a local request, the node I3 may transmit a failure or a request included in the received message to the remote node, for example, the node E. The protected interconnection node may transfer the failure information transferred by a working interconnection node or traffic end node included in a neighboring protected domain to the end node and the working interconnection node. Through this, the protection switching may be performed, and an available path, for example, the working path, the interconnected path, and the protection path may be used to transfer the traffic. Based on the protection switching process, the traffic may be transferred to another protected domain or the traffic may be blocked not to be transferred to the other protected domain. Accordingly, a network divided into multiple domains may be protected.

When local failures and the transferred remote failure information indicates failures occurring in two differing paths, for example, the working path failure and the interconnected path failure, at least one of the end node, the protected interconnection node, and the working interconnection node may indicate the multiple failures in failure information transference message or incorporate multiple-failure information in the failure information transference message, and transmit the failure information transference message indicating the multiple failures or including the multiple-failure information. Based on a multiple failure indication, each node may use a path other than the working path and perform the protection switching although the failure occurs in a path other than the working path. The protected interconnection node may manage information on at least one path failure based on the transferred failure information, and perform the protection switching. Also, the protected interconnection node may provide the failure information to the traffic end node and the working interconnection node. Based on the failure information, the traffic end node and the working interconnection node may manage the information on at least one path failure, for example, a path failure occurring state, and perform the protection switching.

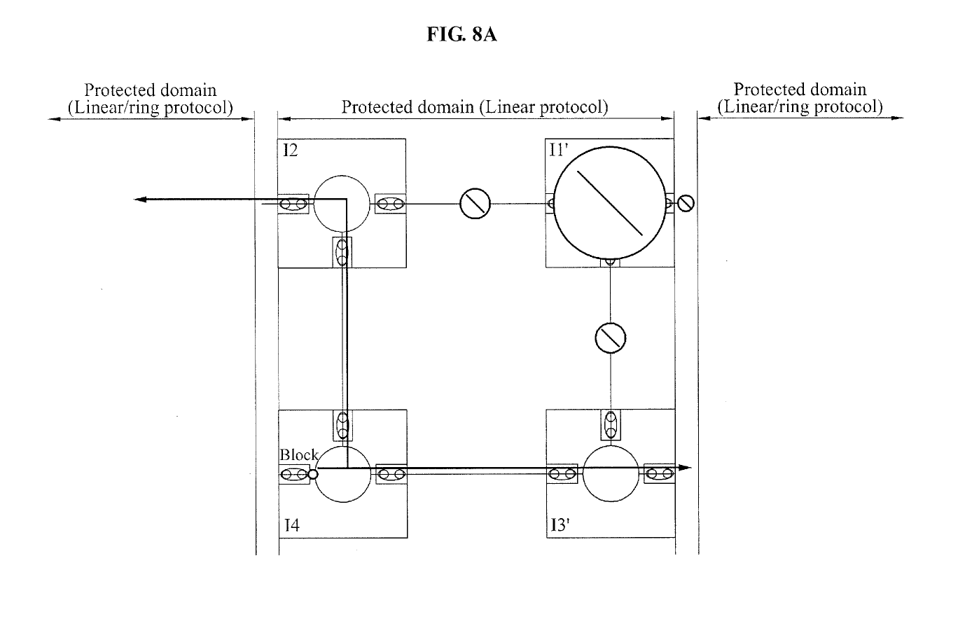

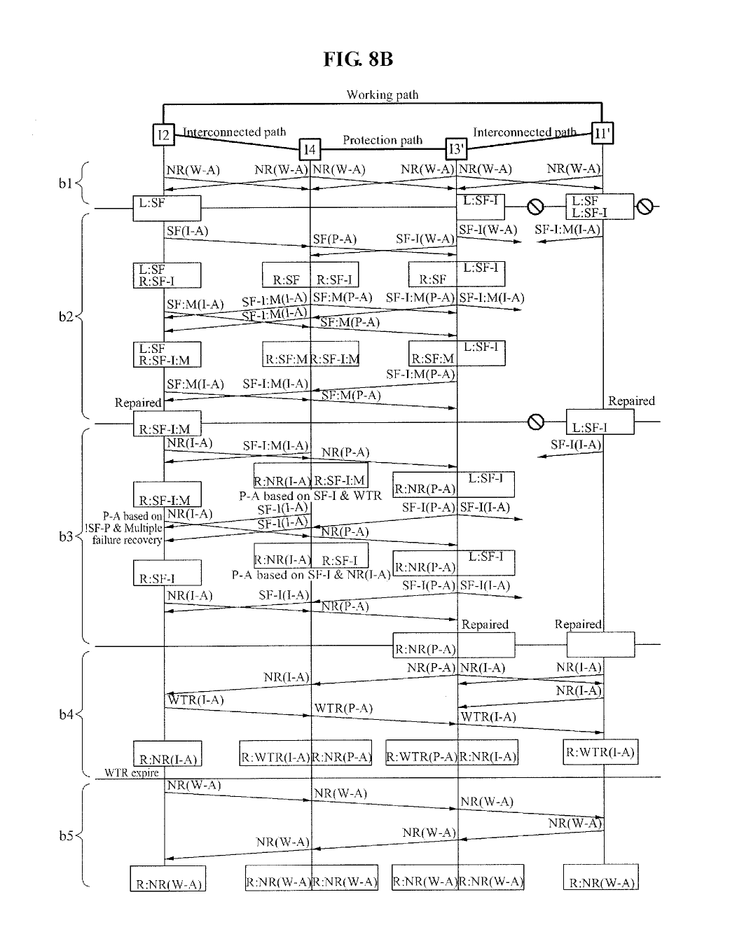

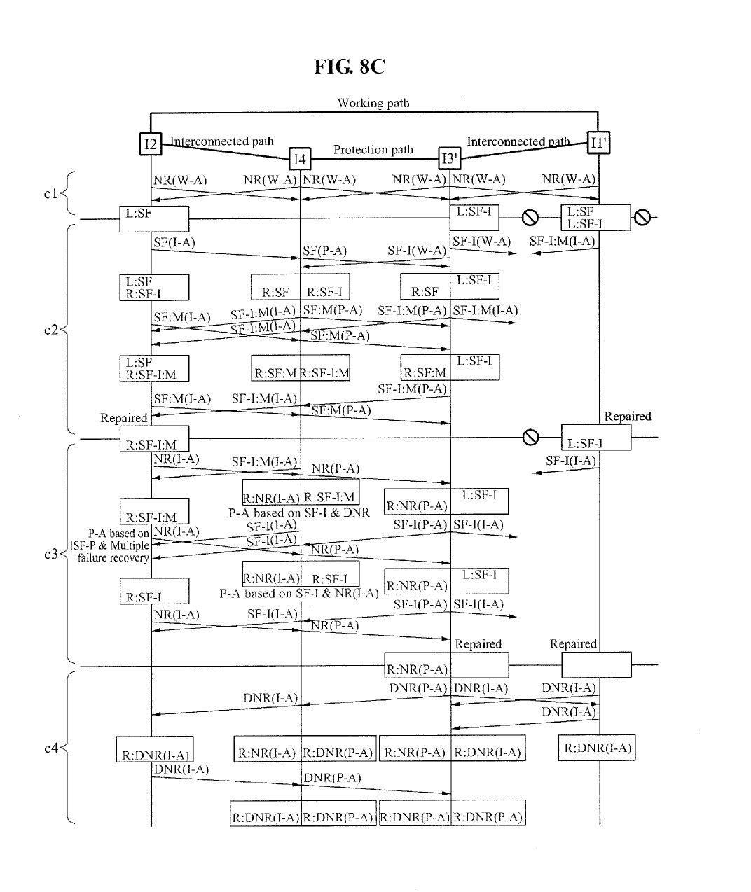

Although the multiple failures are indicated in the failure information and the failure information is transferred from one side, the protected interconnection node may not transfer a message indicating the multiple failures to another node when the received failure information is not information on at least two differing path failures, for example, when a failure being received by another side disappears. Here, the protected interconnection node may transfer the failure information when the local failure of the protected interconnection node is present, and the protected interconnection node may transfer the message to the opponent node from which the message is transmitted when the local failure of the protected interconnection node is absent. As an example, referring to FIG. 8B, a node I4 may not have a local failure. In b2, the node I4 may receive a message SF-I:M(P-A) from a node I3′, and receive a message SF:M(I-A) from the node I2. When the working path failure disappears, for example, in b3, the node I4 may receive the message NR(I-A) from the node I2. For example, in b3, the node I4 may receive the NR information from the node I2. Here, since the node I4 does not have the local failure of the node I4, the node I4 may transfer the NR information to the node I3′ although the message SF-I:M(P-A) is received from the node I3′. For example, a message transference of the protected interconnection node may be performed based on a method in which a local failure or remote failure information of a side receiving a message is determined based on a priority and failure information is transferred to be transmitted to a node connected to an opponent path through the opponent path in lieu of a path for receiving the message. Thus, a message transmitted through a path may differ from a message received by one side through the same path.

When failures occur in two path of both sides in the protected domain, and when the failures are not a bi-directional failure and a one-directional failure, for example, a one-directional failure from the node I3 to the node E and a one-directional failure from the node I3 to the node I1, the protected interconnection node may indicate the multiple failure in a message and transmit the message only when the failures occurs in two differing paths. As an example, referring to FIG. 7B, although failures occur in two paths of both sides of the node I3, the failures may not be bi-directional failures and may be one-directional failures. In this example, the one-direction failures may be the one-directional failure from the node I3 to the node E and the one-directional failure from the node I3 to the node I1. In this example, the node I3 may indicate the multiple failures in a message and transmit the message only when each of the two paths is a different path.

When the multiple failures such as the working path failure and the interconnected path failure occur in the protected domain, and when a higher priority failure than the working path failure and the interconnected path failure is absent, the protected interconnection node may maintain a use of the protection path and/or the working path until the interconnected path failure is solved.

Also, when the protected interconnection node does not have the local failure, for example, when the received message not corresponding to NR is changed to the NR message, the protected interconnection node may transfer the used path information of the NR message to an opposite side. As an example, similarly to (b 4) of FIG. 7B, the used path information of the NR message may be transferred to the end node. The foregoing example may be based on a function to transfer a new failure or request information to an opponent node from the new failure or the new request information is received in response to a change to the new failure or the new request information when the protected interconnection node does not have the local failure.

Also, the protected interconnection node may perform a switching on the used path when the protected interconnection node receives a message including information on a path differing from the used path of the protected interconnection node, and when a local failure and a request corresponding to a higher priority than that of a failure, a request, or no request of the received message are absent. As an example, similarly to (b 5) of FIG. 7B, the protected interconnection node may use the protection path and/or the working path until the message including the W-A information and the NR information is received from the end node while the protected interconnection node receiving the message WTR(P-A) through the protection path is transmitting the message WTR(I-A) through the interconnected path. In this example, when the message including the W-A information and the NR information is received, the switching may be performed.

During a process of solving all of the multiple failures, for example, while a node is in an NR transmitting state and a received message is in an NR state, the protection path and the interconnected path may be preferentially used when a non-matching of a used path occurs in at least one of the end node, the protected interconnection node, and the working interconnected node, for example, when the working path failure is solved, the interconnected path failure remains, and the working path is not used.

In terms of a failure priority in the protected domain, the working path failure may have the lowest priority and the protection path failure may have the highest priority. Since the interconnected path is allowed to be used as the protection path, the interconnected path may have the same priority as that of the protection path failure. Also, priorities between the interconnected path failure and the protection path failure may be adjusted.

Independently of a process performed by priority, when the multiple failures occur, the traffic may be transmitted and received through the protection path and/or the interconnected path in lieu of the working path.

FIGS. 8A through 8C illustrate another example of a protection switching.

Referring to FIG. 8A, a failure may occur in a working interconnected node, for example, a node I1′ in a protected domain. Also, failures may occur in a path between the nodes I1′ and I2, and a path between the nodes I1 and I3′. Hereinafter, descriptions related to a protection switching process will be provided with reference to FIGS. 8B through 8C.

FIG. 8B illustrates an example of a protection switching performed in a revertive mode when multiple failures occur as illustrated in FIG. 8A.

(b 1)—Normal State

In the normal state, the nodes I2, I4, I3′, and I1 may transmit and receive a message NR including W-A information.

(b 2)—Occurrence of Multiple Failures

A case in which failures occur in a working path and an interconnected path of a protected domain, for example, a case in which multiple failures occur

(b 2-1)

The node I2 may recognize a local working path failure, perform the protection switching, and transmit a message SF including I-A information to the node I4.

When the node I1′ does not have a failure, the node I1′ may verify that the multiple failure occur in the protected domain based on the local working path failure and a local interconnected path failure. Also, the node I1′ may transmit a message including the I-A information and SF-I information and indicating the multiple failures to the node I3′. The failure information transference message may not be transferred to the node I3′ due to the interconnected path failure.

The node I3′ may recognize the local interconnected path failure, and transmit a message including the W-A information and the SF-I information based on a priority to the node I4.

When a message remote SF is received, the node I4 may perform the protection switching process by priority, and transmit a message including P-A information and SF information to the node I3′.

(b 2-2)

When a message SF-I:M:(I-A) is received, the node I2 may verify that the multiple failures occur in the protected domain based on the local working path failure and the remote interconnected path failure, and transmit a message including I-A information and the SF information and indicating the multiple failures to the node I4.

The node I1′ may not receive the failure information transference information due to the interconnected path failure, and a state related to the local working path failure may not be changed. Thus, the node I1′ may periodically transmit the message SF-I:M(I-A) transmitted in advance, to the node I3′ without change in a state.

The node I3′ may not receive the failure information transference information from the node due to I1′ the interconnected path failure. When a message SF(P-A) is received from the node I4, the node I3′ may verify that the multiple failure occur in the protected domain based on the message SF-I and a remote working path message. Through this, the node I3′ may perform the protection switching and transmit the message including the P-A information and the SF-I information and indicating the multiple failures to the node I4.

In response to the message SF(I-A) received from the node I2 and the message SF-I(W-A) from the node I3′, the node I4 may verify that the multiple failures occur in the protected domain. Thus, the node I4 may perform the protection switching. Also, since the node I4 does not have a local failure, the node I4 may transmit the message SF-I:M(I-A) including the I-A information and the SF-I information and indicating the multiple failures to the node I2, and transmit the message SF:M(P-A) including the P-A information and the SF information and indicating the multiple failures to the node I3′.

The protection switching may be performed by transmitting and receiving the traffic through the interconnected path and/or the protection path.

(b 2-3)

When the message SF-I:M(P-A) is received from the node I4, the node I2 may verify that the multiple failures occur and the protection switching is performed based on the local working path failure and the remote interconnected path failure. The node I2 may transmit the message SF:M(I-A) including the I-A information and the SF information and indicating the multiple failures to the node I4.

When the message SF:M(P-A) is received from the node I4, the node I3′ may verify that the multiple failures occur based on the message SF-I and the message SF, and transmit the message SF-I:M(P-A) including the P-A information and the SF-I information and indicating the multiple failures to the node I4.

When the message SF:M(I-A) and the message SF-I:M(P-A) are received, the node I4 may verify that the multiple failures occur in the protected domain, and transfer a message including multiple-failure information and indicating the multiple failures to an opponent side of a side from which a remote failure request is received until the multiple failures are solved.

(b 3)—Solution of Working Path Failure

A case in which the working path failure is solved

(b 3-1)

The node I2 may transmit a message indicating that the local working path failure is solved to the node I4. Here, the message may include I-A information and NR information.

When a message NR(I-A) is received from the node I2, the node I4 may verify that the multiple failure is not found due to the solution of the working path failure of the node I2. Thus, the node I4 may remove an indication of the multiple failures, and transfer a received failure information transference message to counterpart nodes including, for example, the node I3′.

Although the local working path failure is solved, the local interconnected path failure may remain. Thus, the node I1′ may not receive the failure information transference message from the node I3′. The node I1′ may remove the indication of the multiple failures, and transmit a message including the I-A information and the SF-I information or a message including the W-A information and the SF-I information based on the protection switching performed by priority, to the node I3′. Due to the interconnected path failure, the failure information transference message may not be transferred to another node, for example, the node I3′.

When the message NR(P-A) is received from the node I4, the node I3′ may verify that the multiple failures are not found and then remove the indication of the multiple failures.

(b 3-2)

When the node I4 receives the message NR(I-A) from the node I2, the multiple failures may not be found. Thus, since only the remote interconnected path failure remains, the node I4 may transmit a message including the P-A information and the NR information to the node I3′.

When the node I3′ receives the message NR(P-A) from the node I4, the multiple failures may not be found. Thus, since the local interconnected path failure remains, the node I3′ may transmit a message including the P-A information and the SF-I information to be transferred to the node I2 through the node I4. Also, the node I3′ may transmit the message SF-I including interconnected path use information to the node I1′. In this example, due to the interconnected path failure, the message SF-I including the interconnected path use information may not be transmitted to the node I1′.

The node I2 may recognize that the multiple failures are not found in the protected domain when the message SF-I(I-A) is received while receiving the message SF-I:M(I-A) from the node I4.

In the present disclosure, when the traffic is being transmitted through a path differing from the working path due to the working path failure and in response to a request for the protection switching, and when one interconnected path failure exists in lieu of a protection path failure, the working path may not be used as a used path, and the protection path and an interconnected path in which a failure does not occur may be used as the used path although an interconnected path failure having a priority higher than that of the working path failure or equal to that of the protection path failure As an example, in an example of FIG. 8A, when the working path failure between the node I2 and the node I1′ is solved, an interconnected path between the node I2 and the node I4 and a protection path between the node I4 and the node I3′ may be used as the used path. Based on the foregoing example, the present disclosure may differ from a typical linear protection switching.

Also, according to the present embodiment, although not shown in FIGS. 8B and 8C, and FIGS. 7B and 7D, the working path may be used as the used path based on a priority of the typical linear protection switching when only one interconnected path failure occurs. Through this, a message may be transmitted using the working path as the used path.

(b 4)—all Failures are Solved in Response to an Interconnected Path Failure Solved in a Revertive Mode.

A case in which the interconnected path failure is solved

(b 4-1)

To provide notification indicating that the local interconnected path failure is solved, the node I1′ may transmit a message to the node I3′. Here, the message may include I-A information and NR information.

The node I3′ may transmit a message to the node I1′ to provide notification indicating that the local interconnected path failure is solved. Here, the message may include the I-A information and the NR information. Also, the node I3′ may transmit a message including P-A information and the NR information to the node I4.

When the node I4 receiving the message remote SF-I(P-A) from the node I3′ receives the message including the P-A information and the NR information, the node I4 may verify that all failures occurring in the protected domain are solved.

When the node I2 receiving the message remote SF-I(I-A) from the node I4 receives the message including I-A information and the NR information, the node I2 may verify that all failures occurring in the protected domain are solved. Since a local failure is the working path failure, the node I2 may operate a WTR timer in a revertive mode and transmit a message including the I-A information and WTR operating information to the node I4.

The node I4 may transmit a message including the P-A information and the WTR operating information to the node I3′, and the node I3′ may transmit the message including the I-A information and the WTR operating information to the node I1′. The node I1′ may verify that the WTR timer is operated in the protected domain.

(b 5)—WTR Timer Expiration

A case in which the WTR timer is expired

(b 5-1)

When the WTR timer is expired, the node I2 may perform a revertive switching and transmit a message including W-A information and the NR information to the node I4.

When the message including the W-A information and the NR information from the node I2, the node I4 may perform the revertive switching and transfer the message including the W-A information and the NR information to the node I3′.

When the message including the W-A information and the NR information is received from the node I3′, the node I1′ may perform the revertive switching and transmit the message including the W-A information and the NR information to the node I3′. When the message NR(W-A) is received from the node I1′, the node I3′ may perform the revertive switching and transmit the message including the W-A information and the NR information to the node I4. The node I4 may perform the revertive switching and transmit the message including the W-A information and the NR information to the node I2.

The used path may be reverted to be the working path in the protected domain.

Hereinafter, descriptions related to a protection switching process performed in a non-revertive mode will be provided with reference to FIG. 8C.

(c 1) through (c 3) of the protection switching process in the non-revertive mode may be the same as (b-1) through (b 3) of the protection switching process in the revertive mode as described with reference to FIG. 8B. Hereinafter, descriptions related to (c 4) of FIG. 8C will be provided as follows.

(c 4)—Interconnected Path Failure Solution

When the interconnected path failure is solved, the multiple failures may be solved.

In this example, the node I1′ may transmit a message including the I-A information and DNR state information to the node I3′ to provide notification indicating that the local interconnected path failure is solved.

To provide notification indicating that the local interconnected path failure is solved, the node I3′ may transmit a message including the I-A information and the DNR state information to the node I1, and transmit a message including the P-A information and the DNR state information to the node I4.

When the node I4 receiving the message remote SF-I(P-A) from the node I3′ receives a message DNR(P-A), the node I4 may verify that all failures occurring in the protected domain are solved. Since the node I4 is in the non-revertive mode, the node I4 may transmit a message including the I-A information and the DNR state information to the node I2.

When the node I2 receiving the message remote SF-I(I-A) from the node I4 receives a message including the I-A information and DNR state information, the node I2 may verify that all of the failures occurring in the protected domain are solved. Since the node I2 is in the non-revertive mode, the node I2 may transmit a message including the I-A information and the DNR state information.

Despite the solution of the multiple failures, the protection path and the interconnected path may be used as the used path or, for example, a non-revertive process may be performed.

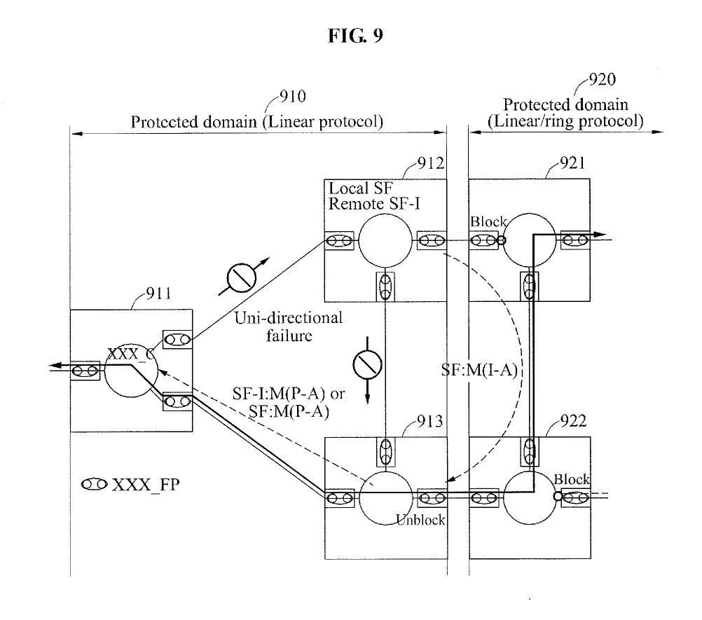

FIG. 9 illustrates still another example of a protection switching.

Referring to FIG. 9, a working interconnection node 912 may detect a multiple failures. As an example, since the working interconnection node 912 does not receive a failure information transference message from an end node 911, the working interconnection node 912 may detect a working path failure. Also, since the working interconnection node 912 receives a failure information transference message including interconnected path failure information from a protected interconnection node 913, the working interconnection node 912 may detect an interconnected path failure. Multiple failure occurrence information may be difficult to be propagated in a protected domain 910 due to a one-directional failure of two differing paths, for example, a working path and an interconnected path. In this example, the working interconnection node 912 recognizing the multiple failures may allow a working interconnection node 921 of a neighboring protected domain 920 to be informed that the multiple failures occur in the protected domain 910.

Since the multiple failures of the protected domain 910 is not recognized by the protected interconnection node 913, the protected interconnection node 913 may need to be informed of the multiple failures occurring in the protected domain 910 so as to perform the protection switching. The working interconnection node 921 may inform a protected interconnection node 922 of the multiple failures occurring in the protected domain 910, and the protected interconnection node 922 may inform the protected interconnection node 913 of the multiple failures occurring in the protected domain 910. A message SF:M(I-A) including I-A information and indicating the multiple failures may be transmitted to the protected interconnection node 913 through the working interconnection node 921 and the protected interconnection node 922.

The protected interconnection node 913 may perform the protection switching, and may transfer failure information transference message to the end node 911 having the multiple failures and not performing the protection switching. As illustrated in FIG. 9, the protected interconnection node 913 may transfer a message SF-I:M(P-A) and a message SF:M(P-A) to the end node 911. The end node 911 may perform the protection switching.

Similarly to an example of FIG. 8A in which the node I1′ detects a local failure based on a failure in a direction from the node I2 to the node I1′ and the node I3′ detects a failure in a direction from the node I1′ to the node I3′, when the multiple failure occurring in a protected domain is difficult to be propagated due to an one-directional failure of two differing paths, an interconnection node detecting the multiple failures may provide notification to an interconnection node of a neighboring protected domain in direct as described in an example of FIG. 8A in which the node I1′ detects multiple failures based on a local SF and a remote SF-I. As an example, when the node I1′ of the FIG. 8A is the same as the node I1′ of FIG. 6A, the node I1′ of FIG. 6A may inform the node I2′ corresponding to an interconnection node of a neighboring protected domain. The node I2′ of FIG. 6A may inform the node I4′ the multiple failures occurring in the protected domain to which the node I1′ belongs. The node I3′ of FIG. 6A may be informed of the multiple failures occurring in the protected domain of the node I3′ from the node I4′, and perform the protection switching. The node I3′ of FIG. 6A may propagate multiple-failure information in the protected domain, and the nodes I2 and I4 of the protected domain having the multiple failure and not performing the protection switching may perform the protection switching.

The interconnected node may receive a single failure remote message of the protected domain of the interconnected node and a multiple failure remote message transferred from the neighboring protected domain. The interconnection node may transfer the multiple failure remote message to another interconnection node or an end node. Also, the interconnected node may indicate the occurrence of the multiple failures in a remote message of the interconnected node through a prioritizing process, and transfer the remote message indicating the occurrence of the multiple failures to the other interconnection node or the end node.

In an example, when multiple failures occur, a first interconnection node of a protected domain may inform an interconnection node of a neighboring protected domain of an occurrence of the multiple failures. To protect a multiple domain segment network, the first interconnection node may control a path to be blocked and unblocked, thereby performing a protection switching. The interconnection node of the neighboring protected domain may receive a message including multiple-failure information from the first interconnection node, and transfer the multiple-failure information to a second interconnection node of the protected domain in which the multiple failures occur, through another interconnection node of the neighboring protected domain. Here, the second interconnection node may be, for example, an interconnection node that does not detect the multiple failures from a protected domain to which the interconnection node belongs. The second interconnection node may control a setting for blocking and unblocking a path to protect a network divided into multiple domains, thereby performing the protection switching. The second interconnection node may inform the end node of the protected domain of the occurrence of the multiple failures, and the end node may perform the protection switching.

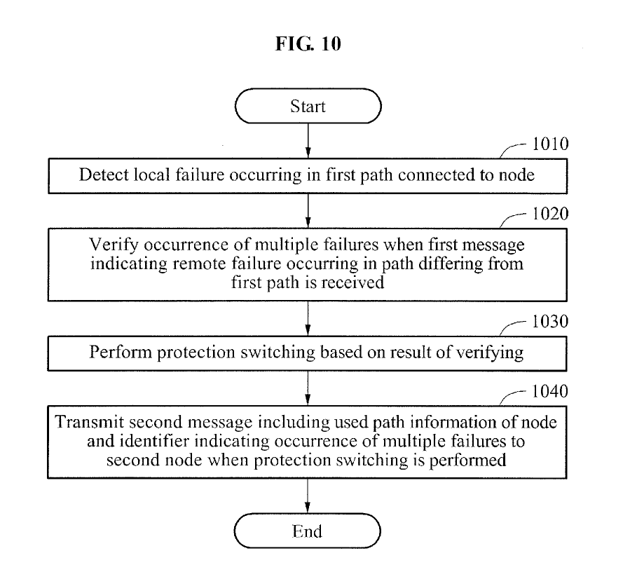

FIG. 10 is a flowchart illustrating an example of an operation method of a node.

Hereinafter, for ease and convenience of description, the following descriptions are provided based on an example of the node E described with reference to FIG. 7B and an example of the node I2 described with reference to FIG. 8B. However, an example of a node is not limited to the node E of FIG. 7B and the node I2 of FIG. 8B.

In an example, a node may include a memory and a process, and operation method of the node may be performed in conjunction between the memory and the processor as illustrated in FIG. 10.

Referring to FIG. 10, in operation 1010, the node may detect a local failure occurring in a first path connected to the node. As an example, the node E of FIG. 7B may detect a local failure occurring in a working path connected to the node E, and the node I2 may detect a local failure occurring in a working path connected to the node I2. The local failure may be a failure recognized by receivers of two nodes mutually connected through one bi-directional path. As an example, when a signal, for example, a message, an electrical signal, and an optical signal received regularly disappears, the node may recognize the local failure. A remote node, for example, a long-distance node may provide notification on a failure occurrence to a counterpart node in a form of a message, and the counterpart node may recognize that a local failure occurs in a remote node in response to the received message. The node may recognize through the message, and the failure recognized through the message may also be referred to as the remote failure.

When the node receives a first message from a second node, the node may verify an occurrence of multiple failures in operation 1020. Here, the first message may indicate a remote failure occurring in a path differing from the first path or include remote failure information of the differing path. Hereinafter, the path differing from the first path may also be referred to as a second path. For example, in operation (b 2), the node E of FIG. 7B may receive a message SF-I(W-A) from a node I3. The message SF-I(W-A) may include failure information of an interconnected path not connected to the node E.

When the multiple failures occur, the node may perform a protection switching in operation 1030.

When the protection switching is performed, the node may transmit a second message including used path information of the node and an identifier indicating the occurrence of the multiple failures to the second node in operation 1040.

When the second node verifies the occurrence of the multiple failures, the node may receive a third message including used path information of the second node and the identifier indicating the occurrence of the multiple failures from the second node. As an example, the node E of FIG. 7B may receive SF-I:M(P-A) from the node I3, and the node I2 of FIG. 8B may receive SF-I:M(I-A) from the node I4.

The node may verify whether the second node performs the protection switching based on the third message. In an example, when the second node performs the protection switching, the node may update a used path and state information of the node.

When the local failure of the first path is solved, the node may transmit a message including NR information and the used path of the node to the second node. As an example, when the local failure of the working path connected to the node E of FIG. 7B is solved, the node E may transmit NR(P-A) to the node I3.

When the second node verifies that the local failure of the first path is solved in response to the message including the NR information, the node may receive a fourth message including the used path information of the second node. In an example of FIG. 7B, the node E may receive SF-I(P-A) from the node I3 in (b 3).

In an example, when a remote failure of the second path is solved, the node may receive a fifth message including the used path information of the second node and identification information of the first path from the second node. When the remote failure is solved in advance to the local failure of the first path, the node may receive the fifth message. In an example of FIG. 7D, the node E may receive SF(P-A) from the node I3 in (d 3). In this example, the node may generate a sixth message including the used path information of the node, and transmit the sixth message to the second node. In the example of FIG. 7D, the node E may transmit SF(P-A) to the node I3.

When the multiple failures are solved, the node may enter a restoration standby state during a standby time. As an example, the node may receive a message including the NR information including the used path information of the second node from the second node, and verify that the multiple failures are solved in response to the received message. Also, when the multiple failures are solved, the node may operate a WTR timer in a revertive mode. In response to the operating of the WTR timer, the node may transmit a message including WTR operating information and the used path of the node, to the second node.

When the standby time ends, the node may perform a revertive operation to switch a used path from a path used after the protection switching to a path used before the protection switching.

Since the foregoing descriptions provided with reference to FIGS. 1 through 9 are also applicable to FIG. 10, repeated descriptions will be omitted for increased clarity and conciseness.

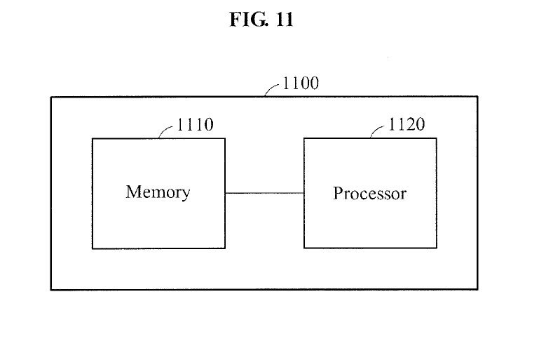

FIG. 11 is a block diagram illustrating a node 1100.

Referring to FIG. 11, the node 1100 may include a memory 1110 and a processor 1120.

The memory 1110 may store an instruction in series, and the processor 1120 may execute the instruction. For example, the processor 1120 may detect a local failure occurring in a first path connected to the node 1100. When the node 1100 receives a first message including remote failure information of a second path not connected to the node 1100, from a second node, the node 1100 may verify an occurrence of multiple failures and perform a protection switching based on a result of the verifying. Also, when the protection switching is performed, the processor 1120 may generate a second message including used path information of the node 1100 and an identifier indicating the occurrence of the multiple failures, and control the node 1100 such that the second message is transmitted to the second node.

Since the foregoing descriptions provided with reference to FIGS. 1 through 10 are also applicable to FIG. 11, repeated descriptions will be omitted for increased clarity and conciseness.

In contrast to a general linear protection switching structure, as an example, when an end point of a working path differs from an end point of a protection path and at least three end nodes are used to perform the protection switching, both end nodes of the protection path may apply a general linear protection switching method, and a working interconnection node at which the working path ends and a protected interconnection node at which the protection path ends may transmit and receive information used for the protection switching to and from each other. Through this, at least two protected domains protected based on a lineal protection switching method may be interconnected to one another.

Also, the working interconnection node and the end node of the traffic may monitor a state of the working path and transfer local failure information of the working path to the protected interconnection node. The end node and the working interconnection node may transfer local failure information of at least one path to be used as the protection path, to the protected interconnection node. The protected interconnection node may transfer local failure information of a path connected to the protected interconnection node to at least one node connected to the protected interconnection node. For example, when a failure occurs in a path connected to the protected interconnection node, the protected interconnection node may transfer failure information to nodes in an opposite side of the path in which the failure occurs. A plurality of nodes included in the protected domain may control a usable path, for example, the working path and the protection path based on a protection switching process, and transfer the traffic to a neighboring protected domain or block the traffic transferred to the neighboring protected domain. Through this, a network divided into multiple domains may be protected.

The failure transference information may be used in a protection switching protocol and included in a message. The node receiving the failure transference information may combine at least two differing link failures based on the received failure transference information and local failure of the node, for example, failure occurring in a link connected to the node. Also, when a failure occurs in another node included in the protected domain, for example, when a node failure occurs, the node may recognize the node failure as multiple failures, for example, a plurality of link failures, and allow the traffic to be transmitted and received through a path connected to a protected interconnection node in which a failure does not occur. The node receiving the transferred failure information may combine at least two differing path failures based on a local failure of the node and the received failure information, recognize at least two failures occurring due to a damage on one node failure in a domain of the node, and allow the traffic to be transmitted and received through a path connected to a protected interconnection node in which a failure does not occur.

A path of nodes in the protected domains may be managed and monitored by segmenting based on a unit of a segment or a unit of a physical path for a failure monitoring. Segmented failure information may be used as an input of a protection switching process, and a final segmentation path or a finally used path in which a failure does not occur may be determined. For example, one logical/physical protection path may be divided into two intervals such that a failure occurrence may be monitored, and the traffic may be transferred through a protection path when all protection paths are not damaged.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An operation method of a node, the method comprising:
recognizing multiple failures occurring in a protected domain;
transmitting a message including failure information, multiple-failure information, and used path information to a second node when the multiple failures are recognized; and
performing a protection switching to a used path determined based on a priority for each of the multiple failures.

2. The method of claim 1, wherein the recognizing comprises recognizing the multiple failures by detecting local failures of differing paths connected to the node, recognizing the multiple failures by verifying multiple-failure information included in a received message, or recognizing the multiple failures by detecting a local failure of a first path connected to the node and verifying information on a remote failure occurring in a path differing from the first path from which the local failure is detected, the information included in a received message.

3. The method of claim 1, wherein when the node is a node recognizing a plurality of local failures of differing paths, the transmitting comprises transmitting, to the second node, a message including the used path information, the multiple-failure information, and information on a failure corresponding to a relatively high priority among the plurality of local failures.

4. The method of claim 3, wherein the performing of the protection switching comprises blocking a path connected to a neighboring protected domain of the protected domain, and
wherein the second node unblocks a second path connected to the neighboring protected domain.

5. The method of claim 1, wherein when the node is a node recognizing a remote failure and a local failure of differing paths, the transmitting comprises transmitting a message including the multiple-failure information, the used path information, and information on the local failure to the second node.

6. The method of claim 1, wherein when the node is a node recognizing the multiple failures based on multiple-failure information included in a previous received message, the transmitting comprises transmitting the message including the failure information, the multiple-failure information, and the used path information to the second node by updating the failure information, the multiple-failure information, and the used path information.

7. The method of claim 1, further comprising:
verifying a solution of the multiple failures in response to a reception of a second message; and
performing, when the solution is verified, a revertive switching to a path used before the protection switching is performed.

8. The method of claim 1, wherein when the node is an interconnection node recognizing a remote failure and a local failure of differing paths, the operation method of the node further comprises:
transmitting information on a higher priority failure between the local failure and the remote failure to the second node; and
transmitting information on a subsequent priority failure to the second node in response to a solution of the higher priority failure, and
wherein the second node recognizes the solution of the higher priority failure in response to the received information on the subsequent priority failure.

9. The method of claim 1, wherein when the node is an interconnection node recognizing a remote failure and a local failure of differing paths, the operation method further comprises comparing a priority of the local failure to a priority of a received message and transmitting failure information included in the received message to the second node when the priority of the received message is higher than the priority of the local failure.

10. The method of claim 1, wherein when the node is a protected interconnection node that is connected to a protection path and an interconnected path, and not connected to a working path, the transmitting comprises transmitting local failure information of the interconnected path to the second node located on one side of the protection path and a third node located on one side of the interconnected path.

11. The method of claim 10, wherein the transmitting of the local failure information comprises transmitting the local failure information to the second node and the third node when the local failure information corresponds to a highest priority failure among the multiple failures, and
wherein the operation method further comprises:
transferring, when the local failure information is absent, information on a remote failure included in the multiple failures to an opponent node of a node to which the information on the remote failure is transmitted; and
transferring, when failure information corresponding to a higher priority than that of the local failure information, the failure information to an opponent node of a node to which the failure information is transmitted.

12. The method of claim 1, wherein when a working path failure among the working path failure, an interconnected path failure, and a protection path failure included in the multiple failures is solved, the used path comprises a protection path and an interconnected path in which a failure does not occur.

13. A node comprising:
a processor configured to recognize multiple failures occurring in a protected domain and perform a protection switching to a used path determined based on a priority for each of the multiple failures when the multiple failures are recognized; and
a communicator configured to transmit a message including failure information, multiple-failure information, and used path information to a second node.

14. The node of claim 13, wherein when the processor recognizes a plurality of local failures of differing paths, the communicator is configured to transmit a message including the used path information, the multiple-failure information, and information on a failure having a relatively high priority among the plurality of local failures to the second node.

15. The node of claim 14, wherein the processor is configured to block a path connected to a neighboring protected domain of the protected domain, and
wherein the second node unblocks a second path connected to the neighboring protection node.

16. The node of claim 13, wherein when the node is an interconnection node recognizing a remote failure and a local failure of a differing path, the communicator is configured to transmit information on a higher priority failure between the local failure and the remote failure to the second node and transmit information on a subsequent priority failure to the second node in response to a solution of the higher priority failure, and
wherein the second node recognizes the solution of the higher priority failure in response to the received information on the subsequent priority failure.

17. The node of claim 13, wherein when the processor recognizes the multiple failures based on multiple-failure information included in a previous received message, the communicator is configured to transmit the message including the failure information, the multiple-failure information, and the used path information to the second node by updating the failure information, the multiple-failure information, and the used path information.

18. The node of claim 13, wherein the processor is configured to verify a solution of the multiple failures in response to a reception of a second message and perform a revertive switching to a path used before the protection switching is performed when the solution is verified.

19. The node of claim 13, wherein when the node is a first protected interconnection node not having a local failure, and when the second node is a second protected interconnection node having the local failure and connected to the node through a protection path,
the communicator is configured to receive a second message including local interconnected path failure information, the multiple-failure information, and protection path use information from the second node, receive a third message including no request information from a third node in response to a solution of one of the multiple failures recognized based on multiple-failure information included in a previous received message, and transmit the no request information to the second node.
